(19) United States
(12) Patent Application Publication
(10) Pub. No.: US 2025/0076198 A1
(43) Pub. Date: Mar. 6, 2025

(54) DETERMINING SPECIES ORDER OF A CONFINED MULTI-SPECIES OBJECT CRYSTAL

(71) Applicant: Quantinuum LLC, Broomfield, CO (US)

(72) Inventors: Brian V. ESTEY, Louisville, CO (US); Maya I. FABRIKANT, Broomfield, CO (US); Paul Levi LAURIA, Broomfield, CO (US); Ivaylo Sashkov MADJAROV, Lafayette, CO (US); Abigail Reiko PERRY, Broomfield, CO (US)

(21) Appl. No.: 18/774,087

(22) Filed: Jul. 16, 2024

Related U.S. Application Data
(60) Provisional application No. 63/535,124, filed on Aug. 29, 2023.

(51) Int. Cl. G01N 21/64; G01N 21/84

(52) U.S. Cl. CPC G01N 21/6404; G01N 21/84; G01N 2021/6406; G01N 2021/8472; G01N 2201/06113

(57) ABSTRACT

A controller of an atomic system controls operation of potential sources to cause potential generating signals to be provided. Application of the potential generating signals to respective potential generating elements causes performance of a split operation causing confinement of a first subset of atomic objects of an object crystal in a first potential well and a second subset of atomic objects of the object crystal in a second potential well. The first subset consists of one or more atomic objects. The object crystal includes atomic objects of at least two species. The controller controls operation of manipulation sources to cause manipulation signals to be incident on the first subset. The controller receives a sensor signal generated by a photodetector configured to capture fluorescence signals generated by the first subset. The controller processes the sensor signal to determine a respective species of at least one atomic object of the first subset.

### CROSS-REFERENCE TO RELATED APPLICATIONS

This application claims priority to U.S. Application No. 63/535,124, filed Aug. 29, 2023, the content of which is incorporated herein by reference in its entirety.

### FIELD

Various embodiments relate to determining the species order of a multi-species object crystal comprising a plurality of atomic objects including at least two different atomic object species.

### BACKGROUND

An ion trap is used to confine ions. In various scenarios, the ions are confined by the ion trap in groups of two or more ions known as ion crystals. In various scenarios, an ion crystal may include ions of different ion species. These ion crystals may be used in an atomic system to perform experiments, controlled quantum state evolution of at least some of the ions, and/or the like. For some experiments, the order of the ion species within the ion crystal is important. However, imaging systems with sufficient resolution to differentiate between single ions are expensive and technically complicated. Through applied effort, ingenuity, and innovation many deficiencies of prior systems and techniques have been solved by developing solutions that are structured in accordance with the embodiments of the present invention, many examples of which are described in detail herein.

### BRIEF SUMMARY OF EXAMPLE EMBODIMENTS

Various embodiments provide systems, system controllers, computer program products, and methods corresponding to determining the species order of atomic objects within a multi-species object crystal. In various embodiments, an object crystal contains a plurality (e.g., two or more) atomic objects. For example, the atomic objects may be neutral or ionic atoms; neutral, charged, or multipolar molecules; and/or the like. In various embodiments, the object crystal includes atomic objects of two or more species. For example, the species of an atomic object is the atomic species, chemical species, or chemical formulation of the atomic object.

In various embodiments, the method for determining the species order of the atomic objects within the multi-species object crystal includes performing a split operation which separates the object crystal into a first subset of the plurality of atomic objects and a second subset of the plurality of atomic objects. A fluorescence detection process is performed on at least the first subset of the plurality of atomic objects and the results of the fluorescence detection process are processed to identify the species present in the first subset of the plurality of atomic objects. The object crystal is recombined and another split operation is performed that separates the object crystal into a first group including the first subset of the plurality of atomic objects and a first atomic object that was originally in the second subset of the plurality of atomic objects and a second group including the remainder of the second subset of the plurality of atomic objects. A fluorescence detection process is performed on at least the first group and the results of the fluorescence detection process are processed to identify the species of the first atomic object that was originally part of the second subset but that is now part of the first group.

According to an aspect of the present disclosure, a method for determining a species of an atomic object of a multi-species object crystal is provided. In an example embodiment, the method includes controlling, by a controller, operation of one or more potential sources to cause a first plurality of potential generating signals to be applied to respective potential generating elements of a confinement apparatus. Application of the first plurality of potential generating signals to the respective potential generating elements causes a potential well to be generated such that an object crystal comprising a plurality of atomic objects is confined within the potential well. The plurality of atomic objects comprises at least two different species of atomic objects. The method further includes controlling, by the controller, operation of the one or more potential sources to cause a second plurality of potential generating signals to be applied to the respective potential generating elements. Application of the second plurality of potential generating signals to the respective potential generating elements causes at least two potential wells to be generated such that a first subset of the plurality of atomic objects is confined in a first potential well of the at least two potential wells and a second subset of the plurality of atomic objects is confined in a second potential well of the at least two potential wells. The method further includes controlling, by the controller, operation of one or more manipulation sources to cause one or more first manipulation signals to be incident on the first subset of the plurality of atomic objects; and receiving, by the controller, a first sensor signal generated by a photodetector configured to capture fluorescence signals generated by the first subset of the plurality of atomic objects. The method further includes controlling, by the controller, operation of the one or more potential sources to cause a third plurality of potential generating signals to be applied to the respective potential generating elements. Application of the third plurality of potential generating signals to the respective potential generating elements causes the first subset of the plurality of atomic objects and a first atomic object from the second subset of the plurality of atomic objects to be confined within the first potential well and a first remainder of the second subset of the plurality of atomic objects to be confined with the second potential well. The method further includes controlling, by the controller, operation of the one or more manipulation sources to cause one or more second manipulation signals to be incident on the first subset of the plurality of atomic objects and the first atomic object from the second subset of the plurality of atomic objects confined within the first potential well; and receiving, by the controller, a second sensor signal generated by a photodetector configured to capture fluorescence signals generated by the first subset of the plurality of atomic objects and the first atomic object from the second subset of the plurality of atomic objects confined within the first potential well. The method further includes determining, by the controller, a species of the first atomic object based at least in part on processing the first sensor signal and the second sensor signal.

In an example embodiment, the method further comprises controlling by the controller operation of the one or more potential sources to cause a fourth plurality of potential generating signals to be applied to the respective potential generating elements, wherein application of the fourth plurality of potential generating signals to the respective potential generating elements causes the first subset of the plurality of atomic objects, first atomic object from the second subset of the plurality of atomic objects, and a second atomic object from the second subset of the plurality of atomic objects to be confined within the first potential well and a second remainder of the second subset of the plurality of atomic objects to be confined with the second potential well; controlling, by the controller, operation of the one or more manipulation sources to cause one or more third manipulation signals to be incident on the first subset of the plurality of atomic objects, the first atomic object from the second subset of the plurality of atomic objects, and the second atomic object from the second subset of the plurality of atomic objects confined within the first potential well; receiving, by the controller, a third sensor signal generated by a photodetector configured to capture fluorescence signals generated by the first subset of the plurality of atomic objects, the first atomic object from the second subset of the plurality of atomic objects, and the second atomic object from the second subset of the plurality of atomic objects confined within the first potential well; and determining, by the controller, a species of the second atomic object.

In an example embodiment, the first subset of the atomic objects consists of a single atomic object and the process is repeated until at least one of (a) all but one of the atomic object from the second subset of atomic objects are confined by the first potential well or (b) all of the atomic objects from the second subset of atomic objects are confined by the first potential well.

In an example embodiment, the method further comprises, based at least in part on the species of the first atomic object, determining an order of the atomic objects of the object crystal.

In an example embodiment, each of the atomic objects of the plurality of atomic objects have the same charge.

In an example embodiment, the one or more potential sources are voltage sources, the potential generating signals are voltage signals, and the respective potential generating elements are respective control electrodes.

In an example embodiment, the one or more manipulation sources are lasers and the one or more first manipulation signals and the one or more second manipulation signals are laser beams.

In an example embodiment, the plurality of atomic objects are ions and the confinement apparatus is a surface ion trap.

In an example embodiment, the one or more first manipulation signals comprise a manipulation signal characterized by a first fluorescence wavelength and a manipulation signal characterized by a second fluorescence wavelength, an atomic object of a first species of the at least two different species fluoresces at the first fluorescence wavelength, and an atomic object of a second species of the at least two different species fluoresces at the second fluorescence wavelength.

In an example embodiment, the species of the first atomic object is determined based at least in part on a comparison of the first sensor signal and the second sensor signal or a comparison of one or more values determined by processing the first sensor signal and one or more values determined by processing the second sensor signal.

In an example embodiment, the method further comprises, based at least in part on the species of the first atomic object, whether an order of the plurality of atomic objects within the object crystal is a desired order.

In an example embodiment, the method further comprises, responsive to determining that the order of the plurality of atomic objects within the object crystal is not the desired order, causing a reordering of the plurality of atomic objects within the object crystal.

According to another aspect, a system (e.g., an atomic system such as a QCCD-based quantum computer) is provided. In an example embodiment, the system includes a confinement apparatus comprising a plurality of potential generating elements; one or more potential sources configured to generate and provide potential generating signals such that the potential generating signals are applied to respective potential generating elements of the plurality of potential generating elements; one or more manipulation sources configured to generate and provide one or more manipulation signals such that the one or more manipulation signals are incident at a target location defined at least in part by the confinement apparatus; and a controller configured to control operation of the one or more potential sources and the one or more manipulation sources. The controller comprises a memory storing executable instructions and at least one processor. The executable instructions are configured to, when executed by the at least one processor, cause the controller to perform controlling operation of one or more potential sources to cause a first plurality of potential generating signals to be applied to respective potential generating elements of a confinement apparatus. Application of the first plurality of potential generating signals to the respective potential generating elements causes a potential well to be generated such that an object crystal comprising a plurality of atomic objects is confined within the potential well. The plurality of atomic objects comprises at least two different species of atomic objects. The executable instructions are further configured to, when executed by the at least one processor, cause the controller to perform controlling operation of the one or more potential sources to cause a second plurality of potential generating signals to be applied to the respective potential generating elements. Application of the second plurality of potential generating signals to the respective potential generating elements causes at least two potential wells to be generated such that a first subset of the plurality of atomic objects is confined in a first potential well of the at least two potential wells and a second subset of the plurality of atomic objects is confined in a second potential well of the at least two potential wells. The executable instructions are further configured to, when executed by the at least one processor, cause the controller to perform controlling operation of one or more manipulation sources to cause one or more first manipulation signals to be incident on the first subset of the plurality of atomic objects; and receiving a first sensor signal generated by a photodetector configured to capture fluorescence signals generated by the first subset of the plurality of atomic objects. The executable instructions are further configured to, when executed by the at least one processor, cause the controller to perform controlling operation of the one or more potential sources to cause a third plurality of potential generating signals to be applied to the respective potential generating elements. Application of the third plurality of potential generating signals to the respective potential generating elements causes the first subset of the plurality of atomic objects and a first atomic object from the second subset of the plurality of atomic objects to be confined within the first potential well and a first remainder of the second subset of the plurality of atomic objects to be confined with the second potential well. The executable instructions are further configured to, when executed by the at least one processor, cause the controller to perform controlling operation of the one or more manipulation sources to cause one or more second manipulation signals to be incident on the first subset of the plurality of atomic objects and the first atomic object from the second subset of the plurality of atomic objects confined within the first potential well; receiving a second sensor signal generated by a photodetector configured to capture fluorescence signals generated by the first subset of the plurality of atomic objects and the first atomic object from the second subset of the plurality of atomic objects confined within the first potential well; and determining a species of the first atomic object.

In an example embodiment, the executable instructions are further configured to, when executed by the at least one processor, cause the controller to perform controlling by the controller operation of the one or more potential sources to cause a fourth plurality of potential generating signals to be applied to the respective potential generating elements, wherein application of the fourth plurality of potential generating signals to the respective potential generating elements causes the first subset of the plurality of atomic objects, first atomic object from the second subset of the plurality of atomic objects, and a second atomic object from the second subset of the plurality of atomic objects to be confined within the first potential well and a second remainder of the second subset of the plurality of atomic objects to be confined with the second potential well; controlling, by the controller, operation of the one or more manipulation sources to cause one or more third manipulation signals to be incident on the first subset of the plurality of atomic objects, the first atomic object from the second subset of the plurality of atomic objects, and the second atomic object from the second subset of the plurality of atomic objects confined within the first potential well; receiving, by the controller, a third sensor signal generated by a photodetector configured to capture fluorescence signals generated by the first subset of the plurality of atomic objects, the first atomic object from the second subset of the plurality of atomic objects, and the second atomic object from the second subset of the plurality of atomic objects confined within the first potential well; and determining, by the controller, a species of the second atomic object.

In an example embodiment, the first subset of the atomic objects consists of a single atomic object and the process is repeated until at least one of (a) all but one of the atomic object from the second subset of atomic objects are confined by the first potential well or (b) all of the atomic objects from the second subset of atomic objects are confined by the first potential well.

In an example embodiment, the executable instructions are further configured to, when executed by the at least one processor, cause the controller to perform, based at least in part on the species of the first atomic object, determining an order of the atomic objects of the object crystal.

In an example embodiment, each of the atomic objects of the plurality of atomic objects have the same charge.

In an example embodiment, the one or more potential sources are voltage sources, the potential generating signals are voltage signals, and the respective potential generating elements are respective control electrodes.

In an example embodiment, the one or more manipulation sources are lasers and the one or more first manipulation signals and the one or more second manipulation signals are laser beams.

In an example embodiment, the plurality of atomic objects are ions and the confinement apparatus is a surface ion trap.

In an example embodiment, the one or more first manipulation signals comprise a manipulation signal characterized by a first fluorescence wavelength and a manipulation signal characterized by a second fluorescence wavelength, an atomic object of a first species of the at least two different species fluoresces at the first fluorescence wavelength, and an atomic object of a second species of the at least two different species fluoresces at the second fluorescence wavelength.

In an example embodiment, the species of the first atomic object is determined based at least in part on a comparison of the first sensor signal and the second sensor signal or a comparison of one or more values determined by processing the first sensor signal and one or more values determined by processing the second sensor signal.

In an example embodiment, the executable instructions are further configured to, when executed by the at least one processor, cause the controller to perform, based at least in part on the species of the first atomic object, whether an order of the plurality of atomic objects within the object crystal is a desired order.

In an example embodiment, the executable instructions are further configured to, when executed by the at least one processor, cause the controller to perform, responsive to determining that the order of the plurality of atomic objects within the object crystal is not the desired order, causing a reordering of the plurality of atomic objects within the object crystal.

According to another aspect, a method is provided. In an example embodiment, the method comprises controlling, by a controller, operation of one or more potential sources to cause a first plurality of potential generating signals to be applied to respective potential generating elements of a confinement apparatus. Application of the first plurality of potential generating signals to the respective potential generating elements causes a potential well to be generated such that an object crystal comprising a plurality of atomic objects is confined within the potential well and the plurality of atomic objects comprises at least two different species of atomic objects. The method further comprises controlling, by the controller, operation of the one or more potential sources to cause a second plurality of potential generating signals to be applied to the respective potential generating elements. Application of the second plurality of potential generating signals to the respective potential generating elements causes at least two potential wells to be generated such that a first subset of the plurality of atomic objects is confined in a first potential well of the at least two potential wells and a second subset of the plurality of atomic objects is confined in a second potential well of the at least two potential wells. The first subset of atomic objects consist of one or more atomic objects. The method further comprises controlling, by the controller, operation of one or more manipulation sources to cause one or more first manipulation signals to be incident on the first subset of the plurality of atomic objects; receiving, by the controller, a first sensor signal generated by a photodetector configured to capture fluorescence signals generated by the first subset of the plurality of atomic objects; and processing the first sensor signal to determine a respective species of at least one atomic object of the one or more atomic objects of the first subset of the plurality of atomic objects.

In an example embodiment, the first subset of the plurality of atomic objects consists of one atomic object and the respective species of the at least one atomic object is determined and stored in a classical memory of the controller.

According to another aspect, a controller is provided. The controller includes at least one processor, a memory, one or more driver controller elements, and one or more analog digital (A/D) converters. The one or more driver controller elements are configured to control operation of respective potential sources and/or manipulation sources. The one or more A/D converters are configured to receive sensor signals generated by respective photodetectors. The memory stores computer executable instructions configured to, when executed by the at least one processor, cause the controller to perform one or more methods disclosed herein.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic diagram illustrating an example atomic system comprising an confinement apparatus configured to confine multi-species object crystals, according to an example embodiment.

FIG. 2 is a top view of a portion of an example confinement apparatus, according to an example embodiment.

FIG. 3A is a flowchart illustrating an example iteration of a multi-iteration method for determining a species order of an example object crystal, according to an example embodiment.

FIG. 3B provides conceptual diagrams illustrating the object crystal at various points of time during the multi-iteration method illustrated in FIG. 3A, according to an example embodiment.

FIG. 3C provides plots illustrating example sensor signals received as part of performing the multi-iteration method illustrated in FIG. 3A, according to an example embodiment.

FIG. 4 provides a schematic diagram of an example controller of an atomic system configured to perform a multi-iteration method for determining a species order of an example object crystal, according to various embodiments.

FIGS. 5A, 5B, and 5C provide flowcharts illustrating various processes, procedures, operations, and/or the like performed by, for example, a controller of FIG. 4, for determining and/or confirming a species order of an example object crystal, according to an example embodiment.

FIG. 6 provides a schematic diagram of an example computing entity of a quantum computer system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally,” “substantially,” and “approximately” refer to within engineering and/or manufacturing tolerances and/or within user measurement capabilities, unless otherwise indicated. Like numbers refer to like elements throughout.

In various embodiments, an atomic system includes a confinement apparatus configured to confine atomic objects. In various embodiments, the confinement apparatus is an ion trap (e.g., surface ion trap, Paul trap, and/or the like), optical trap, magnetic trap, and/or other apparatus configured to confine atomic objects. In various embodiments, the confinement apparatus is configured and/or operated to confine the atomic objects in object crystals. Each object crystal contains a plurality of atomic objects. In various embodiments, the atomic objects are neutral or ionic atoms; neutral, charged, or multipolar molecules; and/or the like. In various embodiments, the object crystal includes atomic objects of two or more species. For example, the species of an atomic object is the atomic species, chemical species, or chemical formulation of the atomic object.

In various scenarios, the atomic system is configured to perform experiments on and/or control the quantum state evolution of at least one of the atomic objects of an object crystal. In various embodiments, it is desired for the atomic objects of the object crystal to be in a particular desired species order. Conventionally, determining the species order of an object crystal, such as an ion crystal, is performed using high-resolution imaging of the ion crystal. For example, the high-resolution imaging must have sufficient resolution to resolve individual atomic objects (e.g., atoms, ions, and/or the like). Such imaging systems are expensive and technically complicated to incorporate into an atomic system. Therefore, there are technical challenges regarding determining the species order of an object crystal confined by a confinement apparatus of an atomic system.

Various embodiments provide technical solutions to these technical problems. In particular, various embodiments provide atomic systems, system controllers, computer program products, and methods for determining a species order of atomic objects within an object crystal. In various embodiments, the method includes splitting the atomic objects of the object crystal into subsets that can be physically separated (e.g., by confining each subset in a different potential well) and detecting fluorescence generated by at least one of the subsets of atomic objects in response to manipulation signals being incident thereon. Based on the detected fluorescence, the species of the atomic object(s) in the at least one of the subsets of atomic objects is determined. The process may be repeated N-1 or N times, where N is the number of atomic objects in the object crystal, such that the species of each atomic object and/or the species order of the object crystal is determined. If the species order of the object crystal is not the desired order, the reordering required to place the object crystal in the desired order may be determined and performed.

In an example embodiment where the object crystal includes four atomic objects with two of the atomic objects being of a first species and the other two atomic objects being of a second species, the method includes performing a split operation such that the object crystal that was previously contained within a single potential well of the confinement apparatus, to be split between two potential wells. The split operation is performed such that a first subset of the plurality of atomic objects of the object crystal are confined within a first potential well and a second subset of the plurality of atomic objects of the object crystal are confined within a second potential well. In an example embodiment, the first subset of the plurality of atomic objects includes a single atomic object and the second subset of the plurality of atomic objects includes the other three atomic objects of the object crystal. A fluorescence detection process is performed on at least the first subset of the plurality of atomic objects. For example, a manipulation signal (e.g., a laser beam) characterized by a fluorescence wavelength corresponding to the first species is incident on the first subset of the plurality of atomic objects and any resulting fluorescence emitted by the first subset of the plurality of atomic objects is detected. A manipulation signal characterized by a fluorescence wavelength corresponding to the second species is incident on the first subset of the plurality of atomic objects and any resulting fluorescence emitted by the first subset of the plurality of atomic objects is detected. As the first subset of the plurality of atomic objects includes a single atomic object, in this example, the species of the single atomic object in the first subset of the plurality of atomic objects is determined based on the wavelength of fluorescence emitted by the first subset of the plurality of atomic objects and/or which manipulation signal caused the first subset of the plurality of atomic objects to fluoresce.

The object crystal is recombined into a single potential well and another split is performed such that the first subset of the plurality of atomic objects and a first atomic object that was previously in the second subset of the plurality of atomic objects are confined within a first potential well and the remainder (e.g., the other two) atomic objects of the second subset of the plurality of atomic objects are confined with a second potential well. A fluorescence detection process is performed on the atomic objects confined within the first potential well (e.g., the first subset of the plurality of atomic objects and the first atomic object that was previously in the second subset of the plurality of atomic objects). Based on processing the results of the fluorescence detection process, the species of the first atomic object (that was previously in the second subset of the plurality of atomic objects) is determined.

The object crystal is recombined into a single potential well and another split is performed such that the first subset of the plurality of atomic objects, the first atomic object that was previously in the second subset of the plurality of atomic objects, and a second atomic object that was previously in the second subset of the plurality of atomic objects are confined within a first potential well and the remaining atomic object of the second subset of the plurality of atomic objects is confined with a second potential well. A fluorescence detection process is performed on the atomic objects confined within the first potential well (e.g., the first subset of the plurality of atomic objects, the first atomic object that was previously in the second subset of the plurality of atomic objects, and the second atomic object that was previously in the second subset of the plurality of atomic objects). Based on processing the results of the fluorescence detection process, the species of the second atomic object (that was previously in the second subset of the plurality of atomic objects) is determined.

In an example embodiment, a fluorescence detection process may be performed on the remaining atomic object of the second subset of the plurality of atomic objects to determine the species of the remaining atomic object. In an example embodiment, the object crystal is recombined and (with or without the performance of another split), a fluorescence detection process is performed on all of the atomic objects of the object crystal and the species of the remaining atomic object is determined based on the fluorescence detected as part of the fluorescence detection process. During performance of the order determining method, the order of the atomic objects of the object crystal does not change.

### Example Atomic System

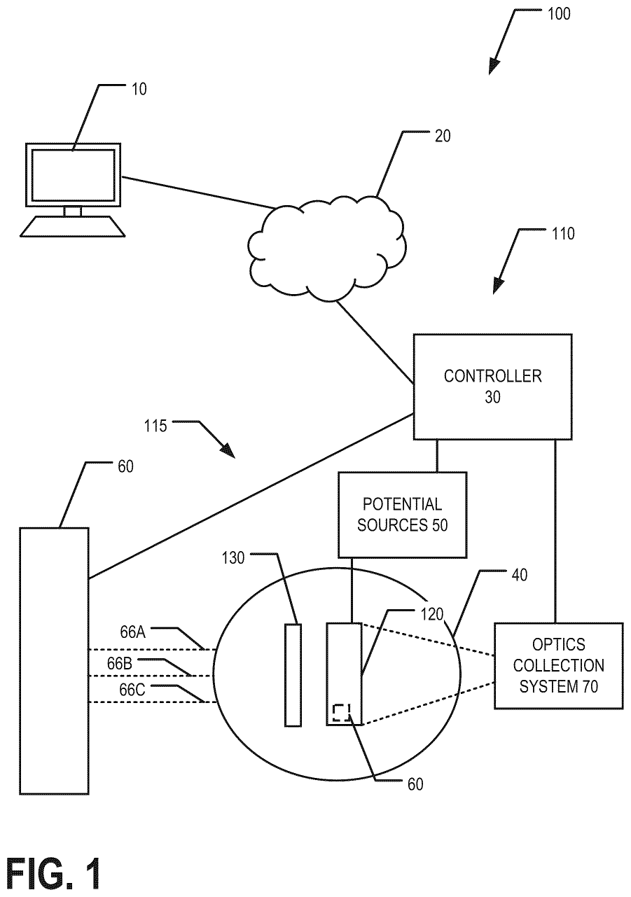

In various embodiments, the object crystal is confined by a confinement apparatus of an atomic system and the object crystal is used to perform experiments, controlled quantum state evolution of at least one of the atomic objects of the object crystal, and/or the like. An example atomic system is a quantum charge-coupled device (QCCD)-based quantum computer. For example, the object crystal may include one or more atomic objects of a first species which are used as qubits of the quantum computer and one or more atomic objects of a second species which are used as sympathetic cooling atomic objects for sympathetically laser cooling the qubits. FIG. 1 provides a schematic diagram of an example atomic system which is a QCCD-based quantum computing system 100, in accordance with an example embodiment. Various other embodiments relate to quantum computers of various other architectures and/or other atomic systems.

In various embodiments, the quantum computing system 100 comprises a computing entity 10 and a quantum computer 110. In various embodiments, the quantum computer 110 comprises a controller 30 and a quantum processor 115 including a cryostat and/or vacuum chamber 40 enclosing a confinement apparatus 120 (e.g., an ion trap), and one or more manipulation sources 60. For example, the cryostat and/or vacuum chamber 40 may be a temperature and/or pressure-controlled chamber. In an example embodiment, the manipulation signals generated by the manipulation sources 60 are provided to the interior of the cryostat and/or vacuum chamber 40 (where the confinement apparatus 120 is located) via corresponding optical path systems 66 (e.g., 66A, 66B, 66C). In various embodiments, the optical path systems 66 are defined, at least in part by one or more components and/or elements (e.g., optical fiber(s), free space optics, waveguides, modulators, and/or the like) of a signal management system.

In an example embodiment, at least one manipulation source 60 is disposed within the cryostat and/or vacuum chamber 40. For example, in an example embodiment, one or more manipulation sources 60 are formed and/or disposed at least in part on and/or in the first substrate on which the confinement apparatus 120 is formed and/or disposed and/or on a second substrate 130 that is mounted in a secured and/or controllable manner with respect to the confinement apparatus 120 within the cryostat and/or vacuum chamber 40.

In an example embodiment, the one or more manipulation sources 60 may comprise one or more coherent optical sources and/or one or more incoherent optical sources. For example, in an example embodiment, the one or more manipulation sources 60 comprise one or more lasers (e.g., optical lasers, microwave sources, VECSELs, VCSELs, and/or the like). In various embodiments, each manipulation source 60 is configured to generate a manipulation signal having a respective characteristic wavelength in the microwave, infrared, visible, or ultraviolet portion of the electromagnetic spectrum. In various embodiments, the one or more manipulation sources 60 are configured to manipulate and/or cause a controlled quantum state evolution of one or more atomic objects confined by the confinement apparatus 120. For example, in an example embodiment, wherein the one or more manipulation sources 60 comprise one or more lasers, the lasers may provide one or more laser beams (e.g., as manipulation signals) to atomic objects confined and/or trapped by the confinement apparatus 120 within the cryostat and/or vacuum chamber 40.

In various embodiments, the manipulation sources 60 include a manipulation source configured to generate manipulation signals characterized by a first fluorescence wavelength λ₁ that corresponds to a wavelength at which a first species of atomic objects fluoresce. In various embodiments, the manipulation sources 60 include a manipulation source to generate manipulation signals characterized by a second fluorescence wavelength λ₂ that corresponds to a wavelength at which a second species of atomic objects fluoresce. In various embodiments where the object crystal includes more than two species of atomic objects (e.g., three species, four species, and/or the like), the manipulation sources 60 include one or more manipulation sources configured to generate manipulation signals characterized by the respective fluorescence wavelength of the additional species of atomic objects (e.g., a third fluorescence wavelength corresponding to a wavelength at which the third species of atomic objects fluoresce, etc.).

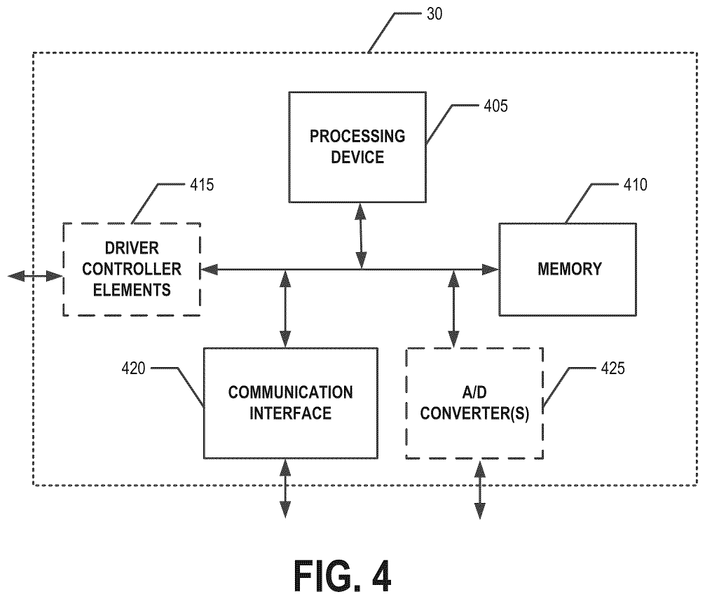

In various embodiments, the quantum computer 110 comprises an optics collection system 70 configured to collect and/or detect photons generated by atomic objects and/or qubits (e.g., during qubit reading procedures and/or fluorescence detection processes). The optics collection system 70 may comprise one or more optical elements (e.g., lenses, mirrors, waveguides, fiber optics cables, and/or the like) and one or more photodetectors. For example, in various embodiments the one or more optical elements are configured to direct light and/or photons generated and/or emitted by an atomic object toward a respective photodetector. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the atomic objects of the object crystals confined by the confinement apparatus 120. In various embodiments, the photodetectors are in electronic communication with the controller 30 via one or more A/D converters 425 (see FIG. 4) and/or the like.

For example, one or more atomic objects may be stimulated (e.g., by one or more manipulation signals) to fluoresce and/or emit light and/or photons at a respective fluorescence wavelength, at least a portion of which is incident on an optical element of the optics collection system 70. The at least a portion of the fluoresced and/or emitted light and/or photons that is incident on the optical element is directed to a respective a photodetector. The photodetector detects the light and/or photons and generates a sensor signal which is an electric signal encoding information about the intensity and/or wavelength of the detected light and/or photons. The controller 30 receives the sensor signal (e.g., via an A/D converter 425) and can then process the signal to determine information regarding the species of one or more atomic objects that were stimulated to fluoresce.

In various embodiments, the quantum computer 110 comprises one or more potential sources 50. In various embodiments, the potential sources 50 generate and provide potential generating signals that, when applied to respective potential generating elements of the confinement apparatus 120, cause the confinement apparatus to generate one or more potential wells configured for confining one or more object crystals that each include a plurality of atomic objects. For example, the potential sources 50 may comprise one or more voltage sources such as a plurality of voltage drivers and/or voltage sources and/or at least one RF driver and/or voltage source. For example, the voltage sources may include arbitrary waveform generators (AWGs), digital analog converters (DACs), and/or other voltage signal generators. The potential sources 50 may be coupled to the corresponding potential generating elements (e.g., electrodes) of the confinement apparatus 120 such that the potential generating signals may be applied to the respective potential generating elements, in an example embodiment. For example, the voltage sources are electrically coupled to the potential generating elements (e.g., electrodes) of the confinement apparatus 120, in an example embodiment where the confinement apparatus is a surface ion trap or a Paul ion trap configured to confine ions using electrical potential wells.

In various embodiments, a (classical and/or semiconductor-based) computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms and/or circuits, and/or the like into a computing language, executable instructions, command sets, and/or the like that the controller 30 can understand and/or implement.

In various embodiments, the controller 30 is a classical and/or semiconductor-based computing device configured to control operation of the potential sources 50, cryostat system and/or vacuum system controlling the temperature and pressure within the cryostat and/or vacuum chamber 40, manipulation sources 60, optics collection system 70, and/or other systems controlling various environmental conditions (e.g., temperature, pressure, and/or the like) within the cryostat and/or vacuum chamber 40 and/or configured to manipulate and/or cause a controlled evolution of quantum states of one or more atomic object confined by the confinement apparatus. For example, the controller 30 may cause a controlled evolution of quantum states of one or more atomic object confined by the confinement apparatus to execute a quantum circuit and/or algorithm. In various embodiments, the controller 30 is configured to receive and process sensor signals to determine one or more results (e.g., atomic object species, for example) based on the performance of one or more fluorescence detection processes. In various embodiments, the at least some of the atomic objects confined by the confinement apparatus 120 are used as qubits of the quantum processor 115 of the quantum computer 110.

### Example Confinement Apparatus

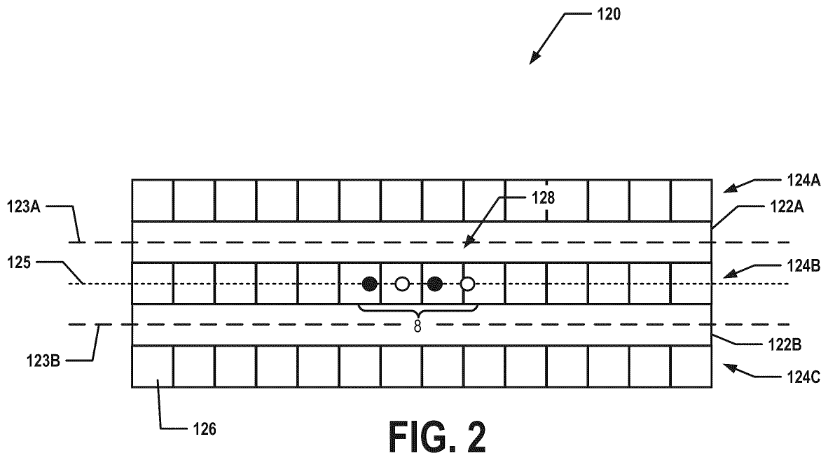

In various embodiments, the confinement apparatus 120 is configured to confine one or more object crystals each comprising a plurality (e.g., two or more) atomic objects. In an example embodiment, the atomic objects are ions and the confinement apparatus 120 is a surface ion trap or a Paul ion trap. A portion of such an example confinement apparatus 120 is illustrated in FIG. 2.

FIG. 2 illustrates a top view of a portion of an example confinement apparatus 120. The illustrated portion of the confinement apparatus 120 includes radio frequency (RF) rails 122A, 122B and three sequences of control electrodes 124A, 124B, 124C. Each sequence of control electrodes 124 comprises a plurality of control electrodes 126.

In various embodiments, RF voltage sources of the potential sources 50 generate and provide an RF voltage signal that is applied to the RF rails 122A, 122B to generate a pseudopotential that defines one or more linear confinement regions (e.g., a 2 or 3-dimensional array of 1-dimensional confinement regions). The atomic objects confined by the confinement apparatus 120 are confined in the one or more linear confinement regions.

In various embodiments, the RF rails 122A, 122B define (at least locally) respective longitudinal axes 123A, 123B. The RF voltage signal applied to the RF rails 122A, 122B generates a pseudopotential having an RF null axis 125. In general, the atomic objects of an object crystal 8 are disposed along the RF null axis 125. For example, the object crystal 8 is formed as a line or linear arrangement of the atomic objects that form the object crystal.

The atomic objects may be maintained at and/or transported between different locations of the confinement apparatus 120 through the application of sets of voltage signals to the control electrodes 126. FIG. 2 shows the object crystal 8 being maintained along the RF null axis 125 at a target location 128. The target location 128 is defined at least in part by the confinement apparatus 120.

For example, in various embodiments, the confinement apparatus 120 may be similar to a confinement apparatus disclosed by U.S. Pat. Nos. 11,037,776; 11,600,482; U.S. application Ser. No. 17/533,587, filed Nov. 23, 2021; or U.S. application Ser. No. 17/810,082, filed Jun. 20, 2022, the contents of which are hereby incorporated by reference herein in their entireties.

### Example Method of Determining the Species Order of an Object Crystal

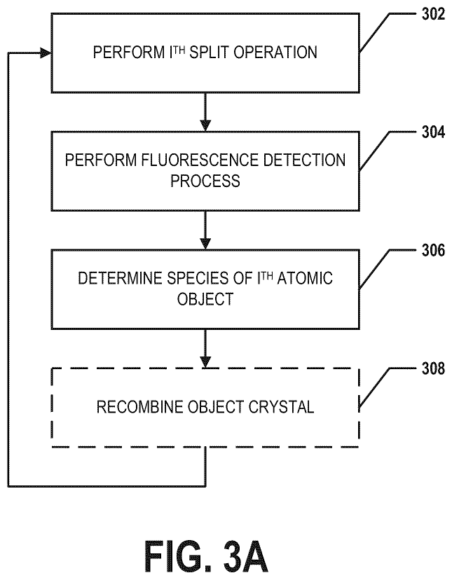

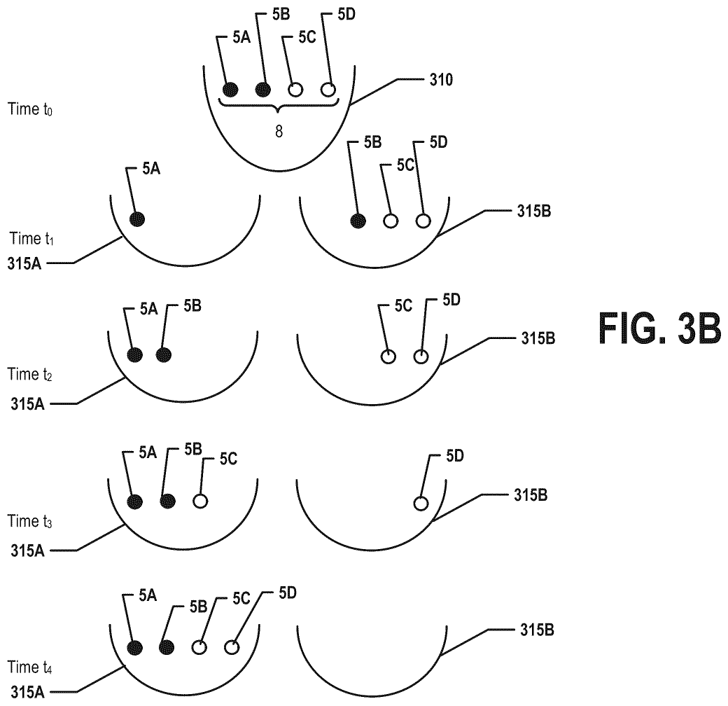

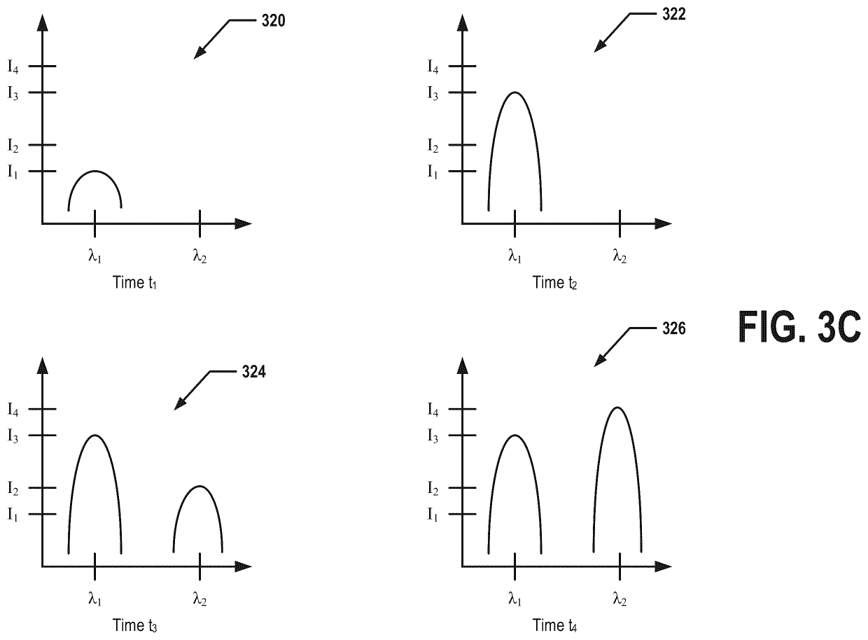

FIG. 3A provides a flowchart illustrating various processes, procedures, operations, and/or the like for determining the respective species of one or more atomic objects of an object crystal and/or determining the species order of an object crystal. In various embodiments, the processes, procedures, operation, and/or the like illustrated in FIG. 3A are performed N-1 or N times, where N is the number of atomic objects in the object crystal. For example, FIG. 3A illustrates performance of one iteration of multi-iteration method for determining a species order of an object crystal. FIG. 3B illustrates various time snap shots of determining the respective species of one or more atomic objects of an object crystal and/or determining the species order of an object crystal where the object crystal includes two atomic objects of a first species and two atomic objects of a second species (e.g., N=4). FIG. 3C illustrates example plots determined and/or generated based on respective sensor signals during various time snap shots of determining the respective species of the atomic objects of the object crystal and/or determining the species order of the object crystal 8 of FIG. 3B.

FIG. 3B illustrates, at time to all of the atomic objects 5 (e.g., 5A, 5B, 5C, 5D) of the object crystal 8 are confined within a single potential well 310. The potential well 310 is generated by the application of a plurality of potential generating signals to respective potential generating elements of the confinement apparatus. For example, in an example embodiment, the atomic objects 5 are ions, the confinement apparatus is a surface ion trap or Paul trap, the potential generating signals are voltage signals, the potential generating elements are control electrodes, and the potential well 310 is an electric potential well.

In the illustrated example, the atomic object 5A and atomic object 5B are of a first species and atomic object 5C and atomic object 5D are of a second species. As should be understood, in various embodiments, the object crystal may include any number of atomic objects (e.g., two or more) and any number of species of atomic objects (e.g., two or more). For example, in an example embodiment, the object crystal includes three atomic objects of a first species, two atomic objects of a second species, and one atomic object of a third species. The atomic objects of the object crystal may be in any order.

At step 302, a split operation is performed. For example, the controller 30 may control operation of one or more potential sources to cause the split operation to be performed. The split operation causes the single potential well 310 to be split into two (or more) potential wells 315A, 315B. The split operation is performed such that, at time t₁, a first subset 2A of atomic objects is confined within the first potential well 315A and a second subset 2B of atomic objects is confined within the second potential well 315B. In the illustrated example, the first subset 2A of atomic objects consists of atomic object 5A and the second subset 2B of the atomic objects consists of atomic object 5B, atomic object 5C, and atomic object 5D. In various embodiments, the first subset 2A of atomic objects comprises a single atomic object. In various embodiments, the ith split operation of the multi-iterative process results in i atomic objects being confined within the first potential well 315A. For example, as a result of the first split operation (i=1), at time t₁, there is one atomic object 5A confined within the first potential well 315A.

At step 304, a fluorescence detection process is performed on the atomic object confined within the first potential well 315A (e.g., the first subset of the plurality of atomic objects). For example, the controller 30 may control operation of one or more manipulation sources 60 to cause a fluorescence detection process to be performed. In various embodiments, performing a fluorescence detection process includes causing a manipulation signal (e.g., a laser beam) characterized by a first fluorescence wavelength λ₁ corresponding to the first species to be incident on the atomic object(s) confined within the first potential well 315A. If any of the atomic objects confined within the first potential well 315A are of the first species, they will fluoresce (e.g., emit light and/or photons at the first fluorescence wavelength λ₁ corresponding to the first species) in response to the manipulation signal characterized by the first fluorescence wavelength being incident thereon. A photodetector that is sensitive to the first fluorescence wavelength λ₁ is configured and/or disposed to collect and/or capture at least a portion of the light and/or photons emitted by the atomic objects confined within the first potential well 315A. A manipulation signal (e.g., a laser beam) characterized by a second fluorescence wavelength λ₂ corresponding to the second species is incident on the atomic object(s) confined within the first potential well 315A. A photodetector that is sensitive to the second fluorescence wavelength λ₂ is configured and/or disposed to collect and/or capture at least a portion of the light and/or photons emitted by the atomic object(s) confined within the first potential well 315A in response to the manipulation signal characterized by the second fluorescence wavelength λ₂ being incident thereon.

In an example embodiment, the manipulation signal characterized by the first fluorescence wavelength λ₁ and the manipulation signal characterized by the second fluorescence wavelength λ₂ are incident on the atomic object(s) confined within the first potential well 315A simultaneously and/or overlapping in time. The wavelength(s) of the light and/or photons collected and/or detected by the photodetector(s) is used to determine the species of the atomic object 5A, which in the illustrated example is the only atomic object confined within the first potential well 315A during the fluorescence detection process. For example, in the illustrated example, the detected and/or collected light and/or photons are of the first fluorescence wavelength λ₁. For example, as shown by FIG. 3C, at time t₁, the sensor signal(s) generated by the photodetector(s) indicate that light and/or photons characterized by the first fluorescence wavelength λ₁ was detected at a first intensity I₁ and light and/or photons characterized by the second fluorescence wavelength λ₂ was not detected during performance of the fluorescence detection process at time t₁.

In another example embodiment, the manipulation signal characterized by the first fluorescence wavelength is incident on the atomic object(s) confined within the first potential well 315A and then any fluorescence resulting from the manipulation signal characterized by the first fluorescence wavelength being incident on the atomic object(s) confined within the first potential well 315A is detected and/or collected. Then, the manipulation signal characterized by the second fluorescence wavelength is incident on the atomic object(s) confined within the first potential well 315A and then any fluorescence resulting from the manipulation signal characterized by the second fluorescence wavelength being incident on the atomic object(s) confined within the first potential well 315A is detected and/or collected. Based on which manipulation signal the atomic object 5A fluoresced in response to, the species of atomic object 5A is determined. For example, in the illustrated embodiment, the atomic object 5A fluoresced in response to the manipulation signal characterized by the first fluorescence wavelength.

In an example embodiment, prior to performing the fluorescence detection process, the first potential well 315A may be moved or transported (e.g., via operation of potential sources 50 by the controller 30) to provide a spatial distance between the first potential well 315A and the second potential well 315B.

At step 306, the species of the atomic object(s) confined within the first potential well 315A is determined and/or identified based on the results of the fluorescence detection process. For example, one or more photodetectors configured to detect fluorescence light and/or photons emitted by the atomic object(s) confined within the first potential well 315A may provide respective sensor signals to a controller 30 of the atomic system 100. FIG. 3C illustrates an example plot 320 representing the sensor signal(s) received by the controller 30 at time t₁ in response to the fluorescence detection process being performed at step 304. As shown by plot 320, fluorescence of the first fluorescence wavelength λ₁ and/or fluorescence emitted in response to the manipulation source characterized by the first fluorescence wavelength λ₁ was detected with a first intensity I₁. Plot 320 also shows that fluorescence of the second fluorescence wavelength λ₂ and/or fluorescence emitted in response to the manipulation source characterized by the second fluorescence wavelength λ₂ was not detected at time t₁.

Based on processing the respective sensor signal(s), the controller 30 determines that the respective sensor signal(s) indicate that the atomic object 5A confined within the first potential well 315A emitted light and/or photons of the first fluorescence wavelength and/or fluoresced in response to the manipulation signal of the first fluorescence wavelength being incident thereon. The controller 30 may then determine, based on the determination that the respective sensor signals indicate that the atomic object 5A confined within the first potential well 315A emitted light and/or photons of the first fluorescence wavelength and/or fluoresced in response to the manipulation signal of the first fluorescence wavelength being incident thereon, that the atomic object 5A is of the first species. In another example, the controller 30 may determine, based on the determination that the respective sensor signals indicate that the atomic object 5A confined within the first potential well 315A did not emit light and/or photons of the second fluorescence wavelength and/or did not fluoresce in response to the manipulation signal of the second fluorescence wavelength being incident thereon, that the atomic object 5A is not of the second species.

In various embodiments, the controller 30 may store the determination that the atomic object 5A is of the first species (and/or is not of the second species) to a (classical and/or semiconductor-based) memory of the controller 30.

At step 308, the object crystal is recombined. For example, the controller 30 may control operation of the potential sources 50 to cause the object crystal to be recombined. For example, in various embodiments, the first and second potential wells 315A, 315B are merged into a single potential well 310 such that all of the atomic objects 5 of the object crystal are confined within the single potential well 310. Notably, the order of the atomic objects 5 within the object crystal 8 has not changed since time to. Another iteration of the multi-iterative method may then be performed.

In another example embodiment, the object crystal is not recombined. Instead, at the next iteration of step 302, the controller 30 causes the next split operation to be performed such that a third potential well is split from the second potential well such that a first atomic object that was previously part of the second subset of the plurality of atomic objects is confined within the third potential well and the remainder of the second subset of the plurality of atomic objects is confined with the second potential well 315B. The third potential well may then be merged with the first potential well 315A such that the first subset of the plurality of atomic objects and the first atomic object that was previously part of the second subset of the plurality of atomic objects are confined together within the first potential well 315A.

In various embodiments where the object crystal was recombined at step 308, the method returns to step 302 and a split operation is performed such that the first subset of the plurality of atomic objects (e.g., the atomic object 5A) and a first atomic object that was previously part of the second subset of the plurality of atomic objects (e.g., the atomic object 5B) are confined within a first potential well 315A at time t₂ and the remainder of the atomic objects of the second subset of the plurality of atomic objects (e.g., atomic objects 5C and 5D) are confined within the second potential well 315B. For example, as a result of the second split operation (i=2), two atomic objects are confined within the first potential well 315A. For example, the controller 30 may control operation of one or more potential sources to cause the split operation to be performed.

At step 304, a fluorescence detection process is performed. For example, the controller 30 of the atomic system causes the manipulation signal characterized by the first fluorescence wavelength and the manipulation signal characterized by the second fluorescence wavelength to be incident on the atomic objects confined within the first potential well 315A. In particular, the manipulation signals are incident on the first subset of the plurality of atomic objects (e.g., atomic object 5A) and the first atomic object that was previously in the second subset of the plurality of atomic objects (e.g., atomic object 5B). The manipulation signals may be provided simultaneously and/or overlapping in time (e.g., in an embodiment where the one or more photodetectors can differentiate between light and/or photons emitted by the atomic objects at the first fluorescence wavelength and light and/or photons emitted by the atomic objects at the second fluorescence wavelength based on the wavelength of the detected light and/or photons) or provided at separate times. The one or more photodetectors capture and/or detect light and/or photons emitted (e.g., fluoresced) by the atomic objects confined within the first potential well 315A (e.g., the atomic objects 5A and 5B) in response to the manipulation signals being incident thereon and provide corresponding sensor signals to the controller 30.

Plot 322 of FIG. 3C illustrates an example representation of the sensor signal(s) provided to the controller 30 by the one or more photodetectors as a result of performance of the fluorescence detection process at time t₂. As shown by plot 322, fluorescence of the first fluorescence wavelength λ₁ and/or fluorescence emitted in response to the manipulation source characterized by the first fluorescence wavelength λ₁ was detected with a third intensity I₃. The third intensity I₃ is greater than the first intensity I₁. For example, the third intensity I₃ may be approximately two times (e.g., 1.5 times to 2.5 times) larger than the first intensity I₁ due to the presence of two atomic objects of the first species in the first potential well 315A. Plot 322 also shows that fluorescence of the second fluorescence wavelength λ₂ and/or fluorescence emitted in response to the manipulation source characterized by the second fluorescence wavelength λ₂ was not detected at time t₂.

At step 306, the species of the first atomic object that was previously part of the second subset of the plurality of atomic objects and is now confined within the first potential well 315A (e.g., atomic object 5B), is determined and/or identified. For example, with respect to the illustrated example, the controller 30 may process the received sensor signal(s) and determine that only fluorescence of the first fluorescence wavelength was detected and/or collected. In another example, the controller 30 may process the received sensor signal(s) and determine that light and/or photons emitted by the atomic objects confined within the first potential well 315A was only detected and/or collected in response to the manipulation signal characterized by the first fluorescence wavelength being incident on the atomic objects confined within the first potential well 315A (e.g., no response to the manipulation signal characterized by the second fluorescence wavelength being incident on the atomic objects confined within the first potential well 315A was detected). In the illustrated example, based on the processing of the received sensor signal(s) controller 30 determines that atomic object 5B is of the first species.

In an example embodiment, the controller 30 compares the sensor signals (and/or values determined based thereon) at time t₂ to the sensor signals (and/or values determined based thereon) at time t₁ to determine a change in the detected fluorescence. For example, the measured intensities at time t₁ may be subtracted from the measured intensities at time t₂ resulting in an indication that the change in the detected fluorescence corresponds to an atomic object of the first species. The controller 30 may determine based thereon that the atomic object 5B is of the first species.

In various embodiments, the controller 30 may store the determination that the atomic object 5B is of the first species to a (classical and/or semiconductor-based) memory of the controller 30.

At step 308, the object crystal is recombined. For example, the controller 30 may control operation of the potential sources 50 to cause the object crystal to be recombined. For example, the first and second potential wells 315A, 315B may be merged into a single potential well 310 such that all of the atomic objects 5 of the object crystal are confined within the single potential well 310. Notably, the order of the atomic objects 5 within the object crystal 8 has not changed since time t₀.

The process is then repeated for a third time. For example, returning to step 302, a split operation is performed such that the first subset of the plurality of atomic objects (e.g., the atomic object 5A), the first atomic object that was previously part of the second subset of the plurality of atomic objects (e.g., the atomic object 5B), and a second atomic object that was previously part of the second subset of atomic object (e.g., the atomic object 5C) are confined within a first potential well 315A at time t₃ and the remaining atomic object of the second subset of the plurality of atomic objects (e.g., atomic object 5D) is confined within the second potential well 315B. For example, as a result of the third split operation (i=3), three atomic objects are confined within the first potential well 315A. For example, the controller 30 may control operation of one or more potential sources to cause the split operation to be performed.

At step 304, a fluorescence detection process is performed. For example, the controller 30 of the atomic system controls operation of one or more manipulation sources to cause the manipulation signal characterized by the first fluorescence wavelength and the manipulation signal characterized by the second fluorescence wavelength to be incident on the atomic objects confined within the first potential well 315A. In particular, the manipulation signals are incident on the first subset of the plurality of atomic objects (e.g., atomic object 5A), the first atomic object that was previously in the second subset of the plurality of atomic objects (e.g., atomic object 5B), and the second atomic object that was previously in the second subset of the plurality of atomic objects (e.g., atomic object 5C). The manipulation signals may be provided simultaneously and/or overlapping in time (e.g., in an embodiment where the one or more photodetectors can differentiate between light and/or photons emitted by the atomic objects at the first fluorescence wavelength and light and/or photons emitted by the atomic objects at the second fluorescence wavelength based on the wavelength of the detected light and/or photons) or provided at separate times. The one or more photodetectors capture and/or detect light and/or photons emitted by the atomic objects confined within the first potential well 315A (e.g., the atomic objects 5A, 5B, and 5C) and provide corresponding sensor signals to the controller 30.

Plot 324 of FIG. 3C illustrates an example representation of the sensor signal(s) provided to the controller 30 by the one or more photodetectors as a result of performance of the fluorescence detection process at time t₃. As shown by plot 324, fluorescence of the first fluorescence wavelength λ₁ and/or fluorescence emitted in response to the manipulation source characterized by the first fluorescence wavelength λ₁ was detected with the third intensity I₃. Plot 324 also shows that fluorescence of the second fluorescence wavelength λ₂ and/or fluorescence emitted in response to the manipulation source characterized by the second fluorescence wavelength λ₂ was detected with a second intensity I₂ at time t₃. The intensity with which fluorescence of the first fluorescence wavelength λ₁ and/or fluorescence emitted in response to the manipulation source characterized by the first fluorescence wavelength λ₁ was detected staying approximately constant compared to the detection thereof at time t₂ and the intensity with which fluorescence of the second fluorescence wavelength λ₂ and/or fluorescence emitted in response to the manipulation source characterized by the second fluorescence wavelength λ₂ was detected increasing from approximately zero to the second intensity I₂, indicates that the second atomic object is of the second species.

At step 306, the species of the second atomic object that was previously part of the second subset of the plurality of atomic objects and is now confined within the first potential well 315A (e.g., atomic object 5C), is determined and/or identified. For example, with respect to the illustrated example, the controller 30 may process the received sensor signal(s) and determine that (two atomic objects worth of) fluorescence of the first fluorescence wavelength was detected and/or collected and (one atomic object worth of) fluorescence of the second fluorescence wavelength was detected and/or collected, as shown by plot 324. In the illustrated example, based on the processing of the received sensor signal(s) controller 30 determines that two atomic objects of the first species are confined within the first potential well 315A and one atomic object of the second species is confined within the first potential well 315A. Based on this determination and the controller knowing that atomic objects 5A and 5B are of the first species, the controller 30 determines that atomic object 5C is of the second species.

In an example embodiment, the controller 30 compares the sensor signals (and/or values determined based thereon) at time t₃ to the sensor signals (and/or values determined based thereon) at time t₂ to determine a change in the detected fluorescence. For example, the measured intensities at time t₂ may be subtracted from the measured intensities at time t₃ resulting in an indication that the change in the detected fluorescence corresponds to an atomic object of the second species. The controller 30 may determine based thereon that the atomic object 5C is of the second species.

In various embodiments, the controller 30 may store the determination that the atomic object 5C is of the second species to a (classical and/or semiconductor-based) memory of the controller 30.

In an example embodiment, a fluorescence detection process is performed on the atomic object 5D confined by the second potential well 315B. For example, the controller 30 of the atomic system controls operation of the one or more manipulation sources 60 to cause the manipulation signal characterized by the first fluorescence wavelength and the manipulation signal characterized by the second fluorescence wavelength to be incident on the remaining atomic object of the second subset of the plurality of atomic objects (e.g., atomic object 5D) confined within the second potential well 315B. The manipulation signals may be provided simultaneously and/or overlapping in time (e.g., in an embodiment where the one or more photodetectors can differentiate between light and/or photons emitted by the atomic objects at the first fluorescence wavelength and light and/or photons emitted by the atomic objects at the second fluorescence wavelength based on the wavelength of the detected light and/or photons) or provided at separate times. One or more photodetectors capture and/or detect light and/or photons emitted by the atomic object confined within the second potential well 315B (e.g., the atomic objects 5D) and provide corresponding sensor signals to the controller 30.

The species of the remaining atomic object of the second subset atomic objects (e.g., atomic object 5D) confined within the second potential well 315B is determined and/or identified based on the results of the fluorescence detection process. For example, one or more photodetectors configured to detect fluorescence light and/or photons emitted by the atomic object(s) confined within the second potential well 315B may provide respective sensor signals to a controller 30 of the atomic system 100. The controller 30 may determine that the respective sensor signals indicate that the atomic object 5D confined within the second potential well 315B emitted light and/or photons of the second fluorescence wavelength and/or fluoresced in response to the manipulation signal of the second fluorescence wavelength being incident thereon. The controller 30 may then determine, based on the determination that the respective sensor signals indicate that the atomic object 5D confined within the second potential well 315B emitted light and/or photons of the second fluorescence wavelength λ₂ and/or fluoresced in response to the manipulation signal of the second fluorescence wavelength λ₂ being incident thereon, that the atomic object 5D is of the second species. In various embodiments, the controller 30 may store the determination that the atomic object 5D is of the first species to a (classical and/or semiconductor-based) memory of the controller 30.

At step 308, the object crystal is recombined. For example, the first and second potential wells 315A, 315B may be merged into a single potential well 310 such that all of the atomic objects 5 of the object crystal are confined within the single potential well 310. Notably, the order of the atomic objects 5 within the object crystal 8 has not changed since time to.

In various embodiments where the species of the remaining atomic object of the second subset of the plurality of atomic objects (atomic object 5D) has been determined and/or identified during the i=N−1 iteration, the controller 30 can now determine the species order of the object crystal by combining the known species of the atomic objects 5A, 5B, 5C, and 5D. In such an embodiment, the i=N iteration (the fourth iteration in this example where N=4) need not be performed to determine the species order of the object crystal. In various embodiments where the species of the remaining atomic object of the second subset of the plurality of atomic objects (atomic object 5D) has not yet been determined and/or identified, the process is repeated again.

For example, returning to step 302, a split operation is performed such that all of the atomic objects 5 of the object crystal 8 are confined within a first potential well 315A at time t₄ and none of the atomic objects of the object crystal 8 confined within the second potential well 315B. In an example embodiment, the split is not performed on the final iteration. For example, in response to the fourth split operation (i=4) four atomic objects are confined by the first potential well 315A. For example, the controller 30 controls operation of one or more potential sources 50 to cause a fourth split operation to be performed, in an example embodiment.

At step 304, a fluorescence detection process is performed. For example, the controller 30 controls operation of one or more manipulation sources 60 to cause a fluorescence detection process to be performed. For example, the controller 30 of the atomic system causes the manipulation signal characterized by the first fluorescence wavelength λ₁ and the manipulation signal characterized by the second fluorescence wavelength λ₂ to be incident on the atomic objects confined within the first potential well 315A (or confined within the single potential well 310 if a split was not performed). In particular, the manipulation signals are incident on all of the atomic objects of the object crystal (e.g., atomic objects 5A, 5B, 5C, and 5D). The manipulation signals may be provided simultaneously and/or overlapping in time (e.g., in an embodiment where the one or more photodetectors can differentiate between light and/or photons emitted by the atomic objects at the first fluorescence wavelength and light and/or photons emitted by the atomic objects at the second fluorescence wavelength based on the wavelength of the detected light and/or photons) or provided at separate times. The one or more photodetectors capture and/or detect light and/or photons emitted by the atomic objects confined within the first potential well 315A and/or single potential well 310 (e.g., the atomic objects 5A, 5B, 5C, and 5D) and provide corresponding sensor signals to the controller 30.

Plot 326 of FIG. 3C illustrates an example representation of the sensor signal(s) provided to the controller 30 by the one or more photodetectors as a result of performance of the fluorescence detection process at time t₄. As shown by plot 326, fluorescence of the first fluorescence wavelength λ₁ and/or fluorescence emitted in response to the manipulation source characterized by the first fluorescence wavelength λ₁ was detected with a third intensity I₃. Plot 326 also shows that fluorescence of the second fluorescence wavelength λ₂ and/or fluorescence emitted in response to the manipulation source characterized by the second fluorescence wavelength λ₂ was detected with a fourth intensity I₄ at time t₄. The fourth intensity I₄ is greater than the second intensity I₂. For example, the fourth intensity I₄ may be approximately two times (e.g., 1.5 times to 2.5 times) larger than the second intensity I₄ due to the presence of two atomic objects of the second species in the first potential well 315A.

At step 306, the species of the remaining atomic object of the second subset of the plurality of atomic objects (e.g., atomic object 5D), is determined and/or identified. For example, with respect to the illustrated example, the controller 30 may process the received sensor signal(s) and determine that (two atomic objects worth of) fluorescence of the first fluorescence wavelength λ₁ was detected and/or collected and (two atomic objects worth of) fluorescence of the second fluorescence wavelength λ₂ was detected and/or collected.

In the illustrated example, based on the processing of the received sensor signal(s) controller 30 determines that two atomic objects of the first species are confined within the first potential well 315A and/or single potential well 310 and two atomic objects of the second species are confined within the first potential well 315A and/or single potential well 310. Based on this determination and the controller knowing that atomic objects 5A and 5B are of the first species and atomic object 5C is of the second species, the controller 30 determines that atomic object 5D is of the second species.

In an example embodiment, the controller 30 compares the sensor signals (and/or values determined based thereon) at time t₄ to the sensor signals (and/or values determined based thereon) at time t₃ to determine a change in the detected fluorescence. For example, the measured intensities at time t₃ may be subtracted from the measured intensities at time t₄ resulting in an indication that the change in the detected fluorescence corresponds to an atomic object of the second species. The controller 30 may determine based thereon that the atomic object 5D is of the second species.

In various embodiments, the controller 30 may store the determination that the atomic object 5D is of the second species to a (classical and/or semiconductor-based) memory of the controller 30.

At step 308, the object crystal is recombined. For example, the first and second potential wells 315A, 315B may be merged into a single potential well 310 such that all of the atomic objects 5 of the object crystal are confined within the single potential well 310. Notably, the order of the atomic objects 5 within the object crystal 8 has not changed since time t₀.

As the respective species of atomic objects 5A, 5B, 5C, and 5D are now known, the species order of the object crystal is determined. The controller 30 may then determine whether the species order of the object crystal is a desired order. When the controller 30 determines that the species order of the object crystal 8 is a desired order, the controller 30 may then use the object crystal 8 to perform one or more experiments, controlled evolution of the quantum state of one or more of the atomic objects 5 of the object crystal 8, and/or the like. When the controller 30 determines that the species order of the object crystal 8 is not a desired order, the controller 30 may determine a rearrangement necessary for placing the object crystal in the desired order and cause the rearrangement to be performed. For example, in an example embodiment, the object crystal may be reordered and/or rearranged using one or more techniques disclosed in U.S. Pat. No. 11,049,713, the content of which is enclosed herein by reference in its entirety.

After the rearrangement is performed the controller may confirm that the species order of the object crystal is the desired order by determining the species order of the object crystal, in an example embodiment. In an example embodiment, the controller 30 uses the rearranged object crystal to perform one or more experiments, controlled evolution of the quantum state of one or more of the atomic objects 5 of the object crystal 8, and/or the like.

In various embodiments, all the atomic objects of the object crystal have the same electric charge and/or the same multipole. For example, in an example embodiment, each of the atomic objects of the object crystal are singly ionized atoms.

### Example Controller of an Atomic System

In various embodiments, a confinement apparatus 120 is incorporated into a system (e.g., a quantum computer 110 or other atomic system) comprising a controller 30. In various embodiments, the controller is a classical or semiconductor-based computing device. In various embodiments, the controller 30 is configured to control various elements of the system (e.g., quantum computer 110 or other atomic system). For example, the controller 30 may be configured to control operation of the potential sources 50 and the manipulation sources 60, in various embodiments. For example, the controller 30 may be configured to control operation of the potential sources 50 to cause the potential sources 50 to generate pluralities of potential generating signals that cause split operations to be performed on an object crystal, cause a split object crystal to be recombined, and/or to cause a reordering of an object crystal. For example, the controller 30 may be configured to control operation of the manipulation sources 60 to cause performance of a fluorescence detection process.

In various embodiments, the controller 30 is configured to control operation of the potential sources 50, a cryostat system and/or vacuum system controlling the temperature and pressure within the cryostat and/or vacuum chamber 40, manipulation sources 60, cooling system, and/or other systems controlling the environmental conditions (e.g., temperature, humidity, pressure, and/or the like) within the cryostat and/or vacuum chamber 40 and/or other systems configured to manipulate and/or cause a controlled evolution of quantum states of one or more atomic objects confined by the confinement apparatus 120. In various embodiments, the controller 30 may be configured to receive sensor signals from one or more optics collection systems 70.

As shown in FIG. 4, in various embodiments, the controller 30 may comprise various controller elements including processing device 405, memory 410, driver controller elements 415, a communication interface 420, analog-digital converter elements 425, and/or the like. For example, the processing device 405 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products. In an example embodiment, the processing device 405 of the controller 30 comprises a clock and/or is in communication with a clock.

For example, the memory 410 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FORAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 410 may store a queue of commands to be executed to cause a quantum algorithm and/or circuit to be executed (e.g., an executable queue), qubit records corresponding the qubits of quantum computer (e.g., in a qubit record data store, qubit record database, qubit record table, and/or the like), a calibration table, computer program code (e.g., in a one or more computer languages, specialized controller language(s), and/or the like), and/or the like. In an example embodiment, execution of at least a portion of the computer program code stored in the memory 410 (e.g., by a processing device 405) causes the controller 30 to perform one or more steps, operations, processes, procedures and/or the like described herein for providing manipulation signals to quantum object positions and/or collecting, detecting, capturing, and/or measuring indications of emitted signals emitted by quantum objects located at corresponding quantum object positions of the confinement apparatus 120.

In various embodiments, the driver controller elements 415 may include one or more drivers and/or controller elements each configured to control one or more drivers. In various embodiments, the driver controller elements 415 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 405). In various embodiments, the driver controller elements 415 may enable the controller 30 to operate and/or control operation of potential sources 50 (e.g., AWGs, DACs, and/or other voltage sources), manipulation sources 60 (e.g. lasers), cooling system, and/or the like. In various embodiments, the drivers may be laser drivers configured to operate one or manipulation sources 60 to generate manipulation signals; vacuum component drivers; drivers for controlling the flow of current and/or voltage applied to electrodes used for maintaining and/or controlling the trapping potential of the confinement apparatus 120 (and/or other drivers for providing potential generating signals to potential generating elements of the confinement apparatus); cryostat and/or vacuum system component drivers; cooling system drivers, and/or the like.

In various embodiments, the controller 30 comprises means for communicating and/or receiving sensor signals from one or more optical receiver components (e.g., photodetectors of the optics collection system 70). For example, the controller 30 may comprise one or more analog-digital converter elements 425 configured to receive signals from one or more optical receiver components (e.g., a photodetector of the optics collection system 70), calibration sensors, and/or the like.

In various embodiments, the controller 30 may comprise a communication interface 420 for interfacing and/or communicating with a computing entity 10. For example, the controller 30 may comprise a communication interface 420 for receiving executable instructions, command sets, and/or the like from the computing entity 10 and providing output received from the quantum computer 110 (e.g., from an optics collection system 70) and/or the result of a processing the output to the computing entity 10. In various embodiments, the computing entity 10 and the controller 30 may communicate via a direct wired and/or wireless connection and/or via one or more wired and/or wireless networks 20.

### Example Methods for Determining and/or Confirming a Species Order of an Object Crystal

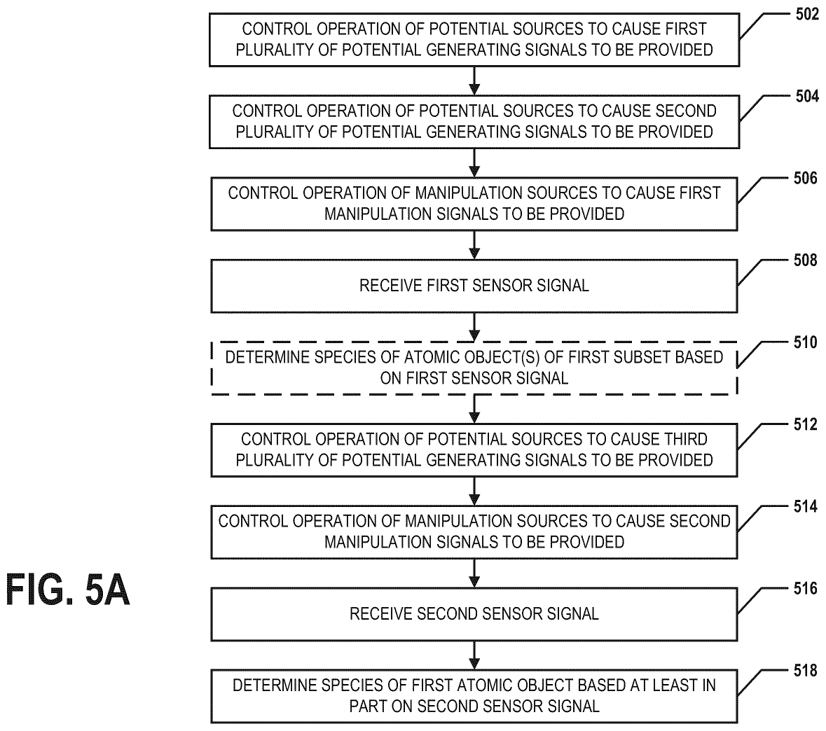

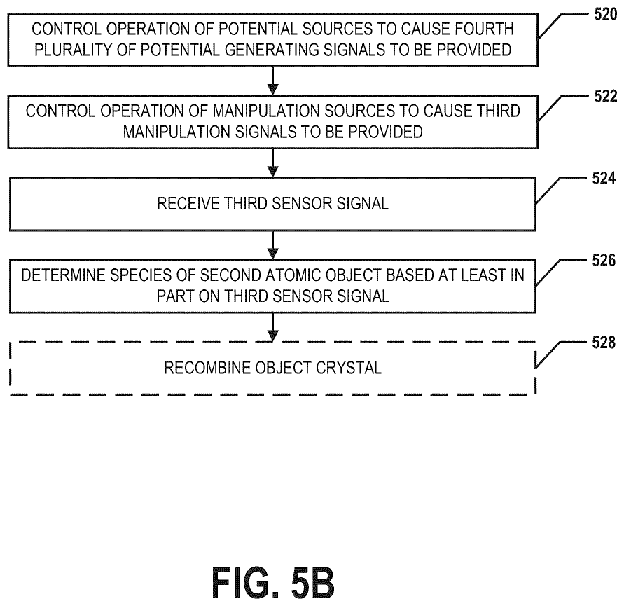

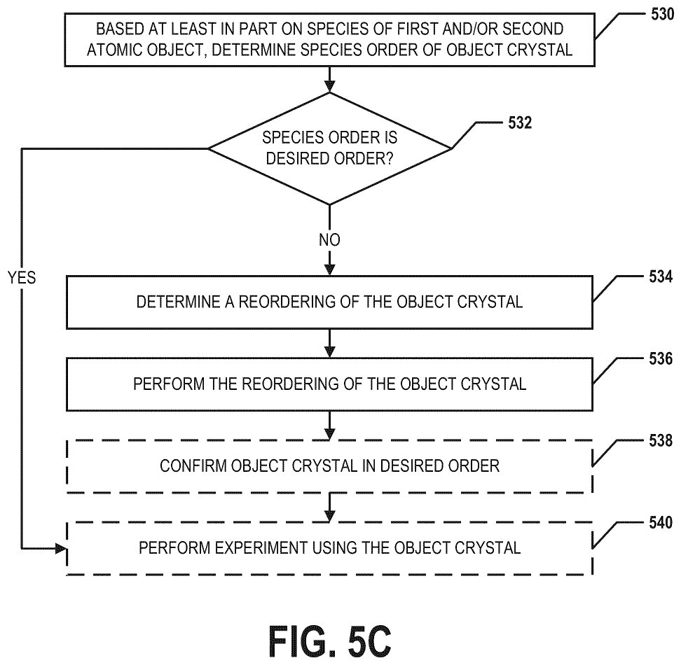

FIG. 5A provides a flowchart illustrating various processes, procedures, operations, and/or the like performed by a controller 30 of an atomic system to determine and/or confirm a species order of an object crystal. For example, the memory 422, 424 of the controller 30 may store executable instructions that when executed by the processing device 408 cause the controller 30 (e.g., via execution of respective executable instructions by the driver controller elements 415) to control operation of various elements of the atomic system (e.g., potential sources 50, manipulation sources 60, and/or the like) to cause the controller 30 to receive sensor signals (e.g., via A/D converter(s) 425) based on which the controller 30 determines and/or confirms the species order of an object crystal confined by the confinement apparatus 120.

Starting at step 502, the controller 30 controls operation of the potential sources 50 to cause the potential sources 50 to generate and provide a first plurality of potential generating signals. For example, the controller 30 comprises means, such as processing device 405, memory 410, driver controller elements 415, and/or the like, for generating and providing a first plurality of potential generating signals. The first plurality of potential generating signals are provided such that respective potential generating signals are applied to respective potential generating elements (e.g., electrodes 126) of the confinement apparatus 120. Application of the first plurality of potential generating signals to the respective potential generating elements causes a potential well (e.g., single potential well 310) to be generated such that an object crystal comprising a plurality of atomic objects is confined within the potential well. The plurality of atomic objects of the object crystal include at least two different species of atomic objects.

At step 504, the controller controls operation of the potential sources 50 to cause the potential sources 50 to generate and provide a second plurality of potential generating signals. For example, the controller 30 comprises means, such as processing device 405, memory 410, driver controller elements 415, and/or the like, for generating and providing a second plurality of potential generating signals. The second plurality of potential generating signals re provided such that respective potential generating signals are applied to respective potential generating elements (e.g., electrodes 126) of the confinement apparatus 120. Application of the second plurality of potential generating signals to the respective potential generating elements causes two potential wells to be generated such that a first subset of the plurality of atomic objects of the object crystal is confined in a first potential well 315A and a second subset of the plurality of atomic objects of the object crystal is confined in a second potential well 315B. For example, application of the second plurality of potential generating signals to the respective potential generating elements causes performance of a split operation such that a first subset (e.g., one or more) of the atomic objects of the object crystal is confined within a first potential well 315A and a second subset of the plurality of atomic objects of the object crystal is confined within a second potential well 315B.

At step 506, the controller 30 controls operation of one or more manipulation sources 60 to cause one or more first manipulation signals to be incident on the first subset of the plurality of atomic objects. For example, the one or more first manipulation signals are incident on the atomic objects confined within the first potential well 315A. For example, the controller 30 comprises means, such as processing device 408, memory 410, driver controller elements 415, and/or the like, for controlling operation of one or more manipulation sources 60 to cause one or more first manipulation signals to be incident on the first subset of the plurality of atomic objects. For example, causing the one or more first manipulation signals to be incident on the first subset of the plurality of atomic objects (e.g., the atomic object(s) confined within the first potential well) is part of performing a fluorescence detection process. For example, the one or more first manipulation signals include a manipulation signal characterized by the first fluorescence wavelength 2 and a manipulation signal characterized by the second fluorescence wavelength 22 to be incident on the atomic objects confined within the first potential well 315A. The first manipulation signals may be provided simultaneously and/or overlapping in time (e.g., in an embodiment where the one or more photodetectors can differentiate between light and/or photons emitted by the atomic objects at the first fluorescence wavelength λ₁ and light and/or photons emitted by the atomic objects at the second fluorescence wavelength λ₂ based on the wavelength of the detected light and/or photons) or provided at separate times.

One or more photodetectors of the optics collection system 70 capture and/or detect light and/or photons emitted by the atomic objects confined within the first potential well 315A (e.g., the first subset of the plurality of atomic objects) and provide corresponding sensor signals to the controller 30. For example, a sensor signal is an electric signal that encodes information regarding a respective photodetector's detection of and/or intensity of light detected that is characterized by the first fluorescence wavelength and/or was emitted (e.g., fluoresced) by the atomic objects confined within the first potential well 315A in response to the manipulation signal characterized by the first fluorescence wavelength being incident thereon, in an example embodiment. In an example embodiment, the sensor signal additionally and/or alternatively electrically encodes information regarding the a respective photodetector's detection of and/or intensity of light detected that is characterized by the second fluorescence wavelength and/or was emitted (e.g., fluoresced) by the atomic objects confined within the first potential well 315A in response to the manipulation signal characterized by the second fluorescence wavelength being incident thereon, in an example embodiment.

At step 508, the controller 30 receives a first sensor signal generated by a photodetector configured to capture fluorescence signals generated by the first subset of the plurality of atomic objects (e.g., the atomic object(s) of the object crystal that are confined within the first potential well 315A). For example, the controller 30 comprises means, such as processing device 405, memory 410, A/D converters 425, and/or the like, for receiving a first sensor signal. The first sensor signal provides information regarding at which of the first fluorescence wavelength and/or the second fluorescence wavelength that atomic object(s) confined within the first potential well 315A fluoresced and/or to which of the first manipulation signals (e.g., the manipulation signal characterized by the first fluorescence wavelength and/or the manipulation signal characterized by the second fluorescence wavelength) the atomic object(s) confined within the first potential well 315A fluoresced.

At step 510, the controller 30 determines the species of the atomic object(s) of the first subset of the plurality of atomic objects of the object crystal. For example, the controller 30 comprises means, such as processing device 405, memory 410, and/or the like, for determining the species of the atomic object(s) of the first subset of the plurality of atomic objects. For example, when the first sensor signal indicates that at least one atomic object of the first subset of the plurality of atomic objects of the object crystal fluoresced at the first fluorescence wavelength and/or in response to the manipulation signal characterized by the first fluorescence wavelength being incident thereon, it is determined that the first subset of the plurality of atomic objects includes at least one atomic object of the first species. In an example embodiment, the intensity with which the at least one atomic object of the first subset of the plurality of atomic objects of the object crystal fluoresced at the first fluorescence wavelength and/or in response to the manipulation signal characterized by the first fluorescence wavelength being incident thereon may be used to determine how many atomic objects of the first species are present in the first subset of the plurality of atomic objects.

In an example embodiment, the controller 30 may use model sensor signals to determine a number of atomic objects of each species indicated by a received sensor signal. For example, the controller 30 may store one or more models indicating an expected sensor signal in an instance where a known number of atomic objects are distributed in various ways between the at least two species present in the object crystal. For example, the one or more models may include a set of a model sensor signals corresponding one atomic object being present in the first potential well where the set of model sensor signals includes a model sensor signal corresponding one atomic object of the first species and another model sensor signal corresponding to one atomic object of the second species. In another example, the one or more models may include a set of a model sensor signals corresponding two atomic objects being present in the first potential well where the set of model sensor signals includes a model sensor signal corresponding to two atomic object of the first species, a model sensor signal corresponding to an atomic object of the first species and an atomic object of the second species, and another model sensor signal corresponding to two atomic objects of the second species. Based on the number of atomic objects present in the first potential well 315A when the sensor signal was generated, the controller 30 may access a set of model sensor signals and compare the model sensor signals of the set of model sensor signals to the received sensor signal to determine a number of atomic objects of each species present in the first potential well 315A when the sensor signal was generated.

In an example embodiment, the controller 30 may process the first sensor signal to determine and/or measure the intensity with which fluorescence at each of the fluorescence wavelengths and/or in response to the manipulation signals of the respective fluorescence wavelengths being incident on the atomic object(s) confined within the first potential well 315A was detected. Based on the determined and/or measured intensity, a number of atomic objects require to provide the determined and/or measured intensity may be determined (e.g., based on an expected intensity range for a single atomic object). The number of atomic object of each species present in the first potential well 315A when the sensor signal was generated may then be determined.

In another example, when the first sensor signal indicates that at least one atomic object of the first subset of the plurality of atomic objects of the object crystal fluoresced at the second fluorescence wavelength and/or in response to the manipulation signal characterized by the second fluorescence wavelength being incident thereon, it is determined that the first subset of the plurality of atomic objects includes at least one atomic object of the second species. In an example embodiment, the intensity with which the at least one atomic object of the first subset of the plurality of atomic objects of the object crystal fluoresced at the second fluorescence wavelength and/or in response to the manipulation signal characterized by the second fluorescence wavelength being incident thereon may be used to determine how many atomic objects of the second species are present in the first subset of the plurality of atomic objects.

In an example embodiment, the first subset of the plurality of atomic objects includes one atomic object and, based on the first sensor signal, whether the one atomic object is of the first species or the second species is determined based on the detected fluorescence.

In various embodiments, the controller 30 may store the determined species of the atomic object(s) of the first subset of the plurality of atomic objects to a (classical and/or semiconductor-based) memory of the controller 30.

At step 512, the controller 30 controls operation of the one or more potential sources 50 to cause to cause the potential sources 50 to generate and provide a third plurality of potential generating signals. For example, the controller 30 comprises means, such as processing device 405, memory 410, driver controller elements 415, and/or the like, for generating and providing a third plurality of potential generating signals. The third plurality of potential generating signals are provided such that respective potential generating signals are applied to respective potential generating elements (e.g., electrodes 126) of the confinement apparatus 120. Application of the third plurality of potential generating signals to the respective potential generating elements causes two potential wells to be generated such that a first subset of the plurality of atomic objects of the object crystal and a first atomic object from the second subset of the plurality of atomic objects (e.g., a first atomic object that was previously part of the second subset of the plurality of atomic objects) are confined in a first potential well 315A and a remainder of the second subset of the plurality of atomic objects of the object crystal (e.g., the second subset of the plurality of atomic objects minus the first atomic object) is confined in a second potential well 315B. For example, application of the third plurality of potential generating signals to the respective potential generating elements causes performance of a combining operation that combines the first and second potential wells 315A, 315B in to a single potential well 310 and then causes performance of a split operation such that the first subset of the plurality of atomic objects of the object crystal and the first atomic object from the second subset of the plurality of atomic objects are confined within the first potential well 315A and a remainder of the second subset of the plurality of atomic objects of the object crystal is confined within the second potential well 315B.

At step 514, the controller 30 controls operation of one or more manipulation sources 60 to cause one or more second manipulation signals to be incident on the first subset of the plurality of atomic objects and the first atomic object. For example, the one or more second manipulation signals are incident on the atomic objects confined within the first potential well 315A. For example, the controller 30 comprises means, such as processing device 408, memory 410, driver controller elements 415, and/or the like, for controlling operation of one or more manipulation sources 60 to cause one or more second manipulation signals to be incident on the first subset of the plurality of atomic objects and the first atomic object. For example, causing the one or more second manipulation signals to be incident on the first subset of the plurality of atomic objects and the first atomic object (e.g., the atomic object(s) confined within the first potential well) is part of performing a fluorescence detection process. For example, the one or more second manipulation signals include a manipulation signal characterized by the first fluorescence wavelength λ₁ and a manipulation signal characterized by the second fluorescence wavelength λ₂. The second manipulation signals may be provided and/or incident on the atomic objects confined within the first potential well 315A simultaneously and/or overlapping in time (e.g., in an embodiment where the one or more photodetectors can differentiate between light and/or photons emitted by the atomic objects at the first fluorescence wavelength λ₁ and light and/or photons emitted by the atomic objects at the second fluorescence wavelength λ₂ based on the wavelength of the detected light and/or photons) or provided at separate times.

One or more photodetectors of the optics collection system 70 capture and/or detect light and/or photons emitted by the atomic objects confined within the first potential well 315A (e.g., the first subset of the plurality of atomic objects) and provide corresponding sensor signals to the controller 30. For example, a sensor signal is an electric signal that encodes information regarding a respective photodetector's detection of and/or intensity of light detected that is characterized by the first fluorescence wavelength and/or was emitted (e.g., fluoresced) by the atomic objects confined within the first potential well 315A in response to the manipulation signal characterized by the first fluorescence wavelength being incident thereon, in an example embodiment. In an example embodiment, the sensor signal additionally and/or alternatively electrically encodes information regarding the a respective photodetector's detection of and/or intensity of light detected that is characterized by the second fluorescence wavelength and/or was emitted (e.g., fluoresced) by the atomic objects confined within the first potential well 315A in response to the manipulation signal characterized by the second fluorescence wavelength being incident thereon, in an example embodiment.

At step 516, the controller 30 receives a second sensor signal generated by a photodetector configured to capture fluorescence signals generated by the first subset of the plurality of atomic objects and the first atomic object (e.g., the atomic object(s) of the object crystal that are confined within the first potential well 315A). For example, the controller 30 comprises means, such as processing device 405, memory 410, A/D converters 425, and/or the like, for receiving a second sensor signal. The second sensor signal provides information regarding at which of the first fluorescence wavelength and/or the second fluorescence wavelength that atomic objects confined within the first potential well 315A fluoresced and/or to which of the second manipulation signals (e.g., the manipulation signal characterized by the first fluorescence wavelength and/or the manipulation signal characterized by the second fluorescence wavelength) the atomic object(s) confined within the first potential well 315A fluoresced. In various embodiments, the second sensor signal provides information regarding the intensity with which the atomic objects confined within the first potential well 315A fluoresced at the first fluorescence wavelength and/or the second fluorescence wavelength and/or in response to the manipulation signal characterized by the first fluorescence wavelength and/or the manipulation signal characterized by the second fluorescence wavelength being incident thereon.

At step 518, the controller 30 determines and/or identifies a species of the first atomic object. The first atomic object was part of the second subset of the plurality of atomic objects when the first manipulation signals were incident on the atomic object(s) confined within the first potential well 315A and was confined within the first potential well 315A when the second manipulation signals were incident on the atomic objects confined within the first potential well 315A. The controller 30 comprises means, such as processing device 405, memory 410, and/or the like for determining and/or identifying a species of the first atomic object.

For example, in an example embodiment, based on the processing of the second sensor signal, the controller 30 determines a number of atomic objects of the first species that were confined within the first potential well 315A when the second manipulation signals were incident on the atomic objects confined by the first potential well 315A and/or a number of atomic objects of the second species that were confined within the first potential well 315A when the second manipulation signals were incident on the atomic objects confined by the first potential well 315A. Based on this determination and the controller knowing that species of the atomic object(s) of the first subset of the plurality of atomic objects, the controller 30 determines the species of the first atomic object. For example, in a scenario where the second sensor signal indicates the presence of an atomic object of the first species and an atomic object of the second species and the controller 30 has previously determined (e.g., at step 510) that the first subset of the plurality of atomic objects consists of an atomic object of the first species, the controller determines that the first atomic object is of the second species. In another example, in a scenario where the second sensor signal indicates the presence of only atomic objects of the first species, the controller 30 determines that the first atomic object is of the first species.

In an example embodiment, the controller 30 compares the second sensor signal (and/or values determined based thereon) to the first sensor signal (and/or values determined based thereon) to determine a change in the detected fluorescence due to the presence of the first atomic object within the first potential well 315A. For example, the measured intensities from the first sensor signal may be subtracted from the measured intensities from the second sensor signal. The difference(s) in the measured intensities from the first sensor signal and the measured intensities from the second sensor signal are due to the first atomic object being added to the first potential well 315A. Therefore, based on the difference(s) in the measured intensities, the controller 30 determines the species of the first atomic object. For example, when the difference in the measured intensities from the first sensor signal and the second sensor signal indicate an increase in fluorescence at the first fluorescence wavelength or an increase in fluorescence in response to a manipulation signal characterized by the first fluorescence wavelength being incident on the atomic objects confined within the first potential well 315A, the controller determines that the first atomic object is of the first species. In another example, when the difference in the measured intensities from the first sensor signal and the second sensor signal indicate an increase in fluorescence at the second fluorescence wavelength or an increase in fluorescence in response to a manipulation signal characterized by the second fluorescence wavelength being incident on the atomic objects confined within the first potential well 315A, the controller determines that the first atomic object is of the second species.

In various embodiments, the controller 30 may store the determined species of the first atomic object to a (classical and/or semiconductor-based) memory of the controller 30.

The object crystal includes atomic objects of at least two species. In an example embodiment where the object crystal includes atomic objects of three species, the one or more manipulation signals include a manipulation signal of a third fluorescence wavelength λ₃ (such that the first, second, and third fluorescence wavelengths are distinguishably different from one another) at which the third species of atomic objects fluoresces. As should be understood, when the object crystal includes atomic objects of four species, the one or more manipulation signals include a manipulation signal of a fourth fluorescence wavelength λ₄ (such that the first, second, third, and fourth fluorescence wavelengths are distinguishably different from one another) at which the fourth species of atomic object fluoresces. Additional manipulation signals characterized by respective wavelengths may be added for additional object species present in the object crystal.

In various embodiments, the process of adding an additional atomic object from the second subset of the plurality of atomic objects to the atomic objects confined by the first potential well may be repeated until the species of each of the atomic objects of the object crystal are determined. For example, the performance of split operations, providing of one or more manipulation signals, receiving of sensor signals, and processing of sensor signals to determine atomic object species may be repeated and/or iterated N times where the object crystal includes N atomic objects.

For example, FIG. 5B provides a flowchart that is a continuation of the flowchart illustrated in FIG. 5A for determining the species of a second atomic object of the object crystal.

Starting at step 520, the controller 30 controls operation of the one or more potential sources 50 to cause the potential sources 50 to generate and provide a fourth plurality of potential generating signals. For example, the controller 30 comprises means, such as processing device 405, memory 410, driver controller elements 415, and/or the like, for generating and providing a fourth plurality of potential generating signals. The fourth plurality of potential generating signals are provided such that respective potential generating signals are applied to respective potential generating elements (e.g., electrodes 126) of the confinement apparatus 120. Application of the fourth plurality of potential generating signals to the respective potential generating elements causes two potential wells to be generated such that a first subset of the plurality of atomic objects of the object crystal, the first atomic object, and a second atomic object from the second subset of the plurality of atomic objects (e.g., a second atomic object that was previously part of the second subset of the plurality of atomic objects) are confined in a first potential well 315A and a remainder of the second subset of the plurality of atomic objects of the object crystal (e.g., the second subset of the plurality of atomic objects minus the first atomic object and the second atomic object) is confined in a second potential well 315B. For example, application of the fourth plurality of potential generating signals to the respective potential generating elements causes performance of a combining operation that combines the first and second potential wells 315A, 315B in to a single potential well 310 and then causes performance of a split operation such that the first subset of the plurality of atomic objects of the object crystal, the first atomic object, and the second atomic object from the second subset of the plurality of atomic objects are confined within the first potential well 315A and a remainder of the second subset of the plurality of atomic objects of the object crystal is confined within the second potential well 315B.

At step 522, the controller 30 controls operation of one or more manipulation sources 60 to cause one or more third manipulation signals to be incident on the first subset of the plurality of atomic objects, the first atomic object, and the second atomic object. For example, the one or more third manipulation signals are incident on the atomic objects confined within the first potential well 315A. For example, the controller 30 comprises means, such as processing device 408, memory 410, driver controller elements 415, and/or the like, for controlling operation of one or more manipulation sources 60 to cause one or more third manipulation signals to be incident on the first subset of the plurality of atomic objects, the first atomic object, and the second atomic object. For example, causing the one or more third manipulation signals to be incident on the first subset of the plurality of atomic objects, the first atomic object, and the second atomic object (e.g., the atomic objects confined within the first potential well) is part of performing a fluorescence detection process. For example, the one or more third manipulation signals include a manipulation signal characterized by the first fluorescence wavelength λ₁ and a manipulation signal characterized by the second fluorescence wavelength λ₂. The third manipulation signals may be provided and/or incident on the atomic objects confined within the first potential well 315A simultaneously and/or overlapping in time (e.g., in an embodiment where the one or more photodetectors can differentiate between light and/or photons emitted by the atomic objects at the first fluorescence wavelength λ₁ and light and/or photons emitted by the atomic objects at the second fluorescence wavelength λ₂ based on the wavelength of the detected light and/or photons) or provided at separate times.

One or more photodetectors of the optics collection system 70 capture and/or detect light and/or photons emitted by the atomic objects confined within the first potential well 315A (e.g., the first subset of the plurality of atomic objects) and provide corresponding sensor signals to the controller 30. For example, a sensor signal is an electric signal that encodes information regarding a respective photodetector's detection of and/or intensity of light detected that is characterized by the first fluorescence wavelength and/or was emitted (e.g., fluoresced) by the atomic objects confined within the first potential well 315A in response to the manipulation signal characterized by the first fluorescence wavelength being incident thereon, in an example embodiment. In an example embodiment, the sensor signal additionally and/or alternatively electrically encodes information regarding the a respective photodetector's detection of and/or intensity of light detected that is characterized by the second fluorescence wavelength and/or was emitted (e.g., fluoresced) by the atomic objects confined within the first potential well 315A in response to the manipulation signal characterized by the second fluorescence wavelength being incident thereon, in an example embodiment.

At step 524, the controller 30 receives a third sensor signal generated by a photodetector configured to capture fluorescence signals generated by the first subset of the plurality of atomic objects, the first atomic object, and the second atomic object (e.g., the atomic objects of the object crystal that are confined within the first potential well 315A). For example, the controller 30 comprises means, such as processing device 405, memory 410, A/D converters 425, and/or the like, for receiving a third sensor signal. The third sensor signal provides information regarding at which of the first fluorescence wavelength and/or the second fluorescence wavelength that atomic objects confined within the first potential well 315A fluoresced and/or to which of the third manipulation signals (e.g., the manipulation signal characterized by the first fluorescence wavelength and/or the manipulation signal characterized by the second fluorescence wavelength) the atomic object(s) confined within the first potential well 315A fluoresced. In various embodiments, the third sensor signal provides information regarding the intensity with which the atomic objects confined within the first potential well 315A fluoresced at the first fluorescence wavelength and/or the second fluorescence wavelength and/or in response to the manipulation signal characterized by the first fluorescence wavelength and/or the manipulation signal characterized by the second fluorescence wavelength being incident thereon.

At step 526, the controller 30 determines and/or identifies a species of the second atomic object. The second atomic object was part of the second subset of the plurality of atomic objects when the first manipulation signals and the second manipulation signals were incident on the atomic object(s) confined within the first potential well 315A and was confined within the first potential well 315A when the third manipulation signals were incident on the atomic objects confined within the first potential well 315A. The controller 30 comprises means, such as processing device 405, memory 410, and/or the like for determining and/or identifying a species of the second atomic object.

For example, in an example embodiment, based on the processing of the third sensor signal, the controller 30 determines a number of atomic objects of the first species that were confined within the first potential well 315A when the third manipulation signals were incident on the atomic objects confined by the first potential well 315A and/or a number of atomic objects of the second species that were confined within the first potential well 315A when the third manipulation signals were incident on the atomic objects confined by the first potential well 315A. Based on this determination and the controller knowing that species of the atomic object(s) of the first subset of the plurality of atomic objects and the first atomic object, the controller 30 determines the species of the second atomic object. For example, in a scenario where the third sensor signal indicates the presence of two atomic objects of the first species and an atomic object of the second species and the controller 30 has previously determined (e.g., at steps 510 and 518) that the first subset of the plurality of atomic objects consists of an atomic object of the first species and the first atomic object is of the second species, the controller determines that the second atomic object is of the first species.

In an example embodiment, the controller 30 compares the third sensor signal (and/or values determined based thereon) to the second sensor signal (and/or values determined based thereon) to determine a change in the detected fluorescence due to the presence of the second atomic object within the first potential well 315A. For example, the measured intensities from the second sensor signal may be subtracted from the measured intensities from the third sensor signal. The difference(s) in the measured intensities from the second sensor signal and the measured intensities from the third sensor signal are due to the first atomic object being added to the first potential well 315A. Therefore, based on the difference(s) in the measured intensities, the controller 30 determines the species of the second atomic object. For example, when the difference in the measured intensities from the second sensor signal and the third sensor signal indicate an increase in fluorescence at the first fluorescence wavelength or an increase in fluorescence in response to a manipulation signal characterized by the first fluorescence wavelength being incident on the atomic objects confined within the first potential well 315A, the controller determines that the second atomic object is of the first species. In another example, when the difference in the measured intensities from the second sensor signal and the third sensor signal indicate an increase in fluorescence at the second fluorescence wavelength or an increase in fluorescence in response to a manipulation signal characterized by the second fluorescence wavelength being incident on the atomic objects confined within the first potential well 315A, the controller determines that the second atomic object is of the second species.

In various embodiments, the controller 30 may store the determined species of the second atomic object to a (classical and/or semiconductor-based) memory of the controller 30.

At step 528, the controller 30 may control operation of the potential sources 50 to cause the potential sources 50 to generate and provide a fifth plurality of potential generating signals. For example, the controller 30 comprises means, such as processing device 405, memory 410, driver controller elements 415, and/or the like, for generating and providing a fifth plurality of potential generating signals. The fifth plurality of potential generating signals are provided such that respective potential generating signals are applied to respective potential generating elements (e.g., electrodes 126) of the confinement apparatus 120. Application of the fifth plurality of potential generating signals to the respective potential generating elements causes the first potential well 315A and the second potential well 315B to be combined into a single potential well 310. For example, application of the fifth plurality of potential generating signals to the respective potential generating elements causes the object crystal to be recombined. Notably, the order of the atomic objects within the object crystal has not changed during the time that has elapsed since the generation and provision of the first potential generating signals at step 502.

FIG. 5C provides a flowchart illustrating various processes, procedures, operations, and/or the like that may be performed by a controller 30 to confirm that the species order of an object crystal is a desired order. For example, in various embodiments, a particular species order of the object crystal is desired for performance of experiments, controlled evolution of the quantum state of at least one atomic object of the object crystal, and/or the like. Therefore, the controller 30 may determine and/or confirm that the species order of the object crystal is the desired order and/or perform remedial action when the species order of the object crystal is not the desired order.

Starting at step 530, the controller 30 determines the species order of the object crystal based at least in part on the species determined for the first atomic object and/or the second atomic object. For example, the controller 30 comprises means, such as processing device 405, memory 410, and/or the like, for determining the species order of the object crystal. For example, after the controller 30 has performed steps 502-518, steps 502-528, and/or additional iterations (e.g., N-1 or N iterations, where the object crystal consist of N atomic objects), the controller 30 determined the species order of the object crystal. For example, the controller 30 may determine the species of one or more atomic objects of the object crystal and based thereon, determine the species order of the object crystal. For example, returning to the example object crystal illustrated in FIG. 3B, the controller 30 determined that the atomic object of the first subset of the plurality of atomic objects was of a first species, the first atomic object was of the first species, the second atomic object was of the second species, and the remaining atomic object was of the second species. The controller 30 may then aggregate the determined species of the atomic objects of the object crystal to determine that the species order of the object crystal is first species, first species, second species, second species, in various embodiments according to the example shown in FIG. 3B.

At step 532, the controller 30 determines whether the species order of the object crystal is the desired order for the particular application. For example, in various embodiments, the desired order is an application appropriate order for the particular application to be performed using the object crystal. For example, the controller 30 comprises means, such as processing device 405, memory 410, and/or the like, for determining whether the species order of the object crystal is the desired order for the particular application. For example, the controller 30 may compare the determined species order of the object crystal to the desired order to determine whether the species order matches the desired order. For example, the species order matches the desired order when an element by element comparison of the species order and the desired order indicate that the species order is the same as the desired order. For example, if the desired order is first species, second species, first species, second species, than the object crystal 8 shown in FIG. 3B is determined to not be of the desired order. In another example, if the desired order is first species, first species, second species second species, than the object crystal 8 shown in FIG. 3B is determined to be of the desired order.

When it is determined that the species order of the crystal is the desired order for the particular application, the process continues to step 540. At step 540, the controller 30 controls the potential sources 50, the manipulation sources 60, and/or other components of the atomic system to cause the atomic system to perform one or more experiments and/or controlled evolution of a quantum state of at least one of the atomic objects of the object crystal.

When it is determined that the species order of the crystal is not the desired order for the particular application, the process continues to step 534. At step 534, the controller 30 determines a reordering of the object crystal to cause the object crystal to be of the desired order. For example, if the desired order is first species, second species, first species, second species, and the object crystal 8 is that shown in FIG. 3B, the controller 30 determines that the two atomic objects in the middle of the crystal need to be swapped. In another example, if the desired order is second species, first species, second species, first species, and the object crystal 8 is that shown in FIG. 3B, the controller 30 determines that the two atomic objects on the outside of the crystal need to be swapped. As disclosed in using one or more techniques disclosed in U.S. Pat. No. 11,049,713, a variety of reordering operations may be performed to reorder the object crystal based on the beginning species order and the desired species order. Thus, the controller 30 may determine and/or select one or more reordering operations from a library of reordering operations (e.g., stored in memory 410) that will reorder the object crystal from the determined species order to the desired order.

At step 536, the controller 30 controls operation of the potential sources 50 to cause one or more reordering pluralities of potential generating signals to be generated and provided to the respective potential generating elements of the confinement apparatus. Application of the one or more reordering pluralities of potential generating signals to the respective potential generating elements cause the one or more determined and/or selected reordering operations to be performed on the object crystal. As a result, the species order of the object crystal is changed. In various embodiments, the controller 30 comprises means, such as processing device 405, memory 410, driver controller elements 415, and/or the like, for controlling operation of the potential sources 50 to cause one or more reordering pluralities of potential generating signals to be generated and provided to the respective potential generating elements of the confinement apparatus.

At step 538, the controller 30 may confirm the object crystal is in the desired order. For example, the controller 30 may control operation of the potential sources 50, manipulation sources 60, and/or the like to cause a multi-iteration process to be performed to determine the species order of the object crystal. For example, the controller 30 may cause the atomic system to perform N-1 or N iterations of the flowchart illustrated in FIG. 3A and/or steps 502-518 or 502-538 to determine the species order of the object crystal. The controller 30 may then determine whether the species order of the object crystal is the desired order. When it is determined that the species order is not the desired order, the controller 30 may reorder the object crystal again, eject the object crystal from the confinement apparatus, and/or the like. When it is determined that the species order is the desired order, the controller 30 may proceed to step 540.

At step 540, the controller 30 controls the potential sources 50, the manipulation sources 60, and/or other components of the atomic system to cause the atomic system to perform one or more experiments and/or controlled evolution of a quantum state of at least one of the atomic objects of the object crystal.

While the steps regarding processing the sensor signals to determine and/or identify the species of various atomic objects are described above as being performed by the controller 30, in various embodiments, the controller 30 provides the sensor signals and/or values determined based thereon to the computing entity 10. The computing entity 10 then processes the sensor signals and/or values determined based thereon to determine and/or identify the species of respective atomic objects of the object crystal. The computing entity 10 may then store the determined species of the respective atomic objects and/or provide the determined species to the controller 30. Similarly, steps 530, 532 and/or 534 may be performed by the computing entity 10, in an example embodiment.

In various embodiments, each of the atomic objects of an object crystal have the same electric charge and/or multipole moment.

### Technical Advantages

In various scenarios, an atomic system includes a confinement apparatus configured to confine multi-species object crystals. The atomic system may be configured to perform experiments on and/or control the quantum state evolution of at least one of the atomic objects of an object crystal. In various embodiments, it is desired for the atomic objects of the object crystal to be in a particular desired species order. For example, the experiments and/or controlled quantum state evolution of the at least one of the atomic objects of the object crystal may only be performed effectively and/or efficiently when the object crystal has the desired species order.

Conventionally, determining the species order of an object crystal, such as an ion crystal, is performed using high-resolution imaging of the ion crystal. For example, the high-resolution imaging must have sufficient resolution to resolve individual atomic objects (e.g., atoms, ions, and/or the like). Such imaging systems are expensive and technically complicated to incorporate into an atomic system. Therefore, technical challenges exist regarding determining and/or confirming the species order of an object crystal confined by a confinement apparatus of an atomic system.

Various embodiments provide technical solutions to these technical problems. In particular, various embodiments provide atomic systems, system controllers, computer program products, and methods for determining a species order of atomic objects within an object crystal. In various embodiments, the method includes splitting the atomic objects of the object crystal into subsets of atomic objects that can be physically separated (e.g., by confining each subset in a different potential well) and detecting fluorescence generated by at least one of the subsets of atomic objects in response to manipulation signals being incident thereon. Based on the detected fluorescence, the species of the atomic object(s) in the at least one of the subsets of atomic objects is determined. The process may be repeated N-1 or N times, where N is the number of atomic objects in the object crystal, such that the species of each atomic object and/or the species order of the object crystal is determined. If the species order of the object crystal is not the desired order, the reordering required to place the object crystal in the desired order may be determined and performed. Thus, various embodiments provide technical improvements that overcome the technical challenges relating to conventional techniques for determining and/or confirming the species order of an object crystal.

### Example Computing Entity

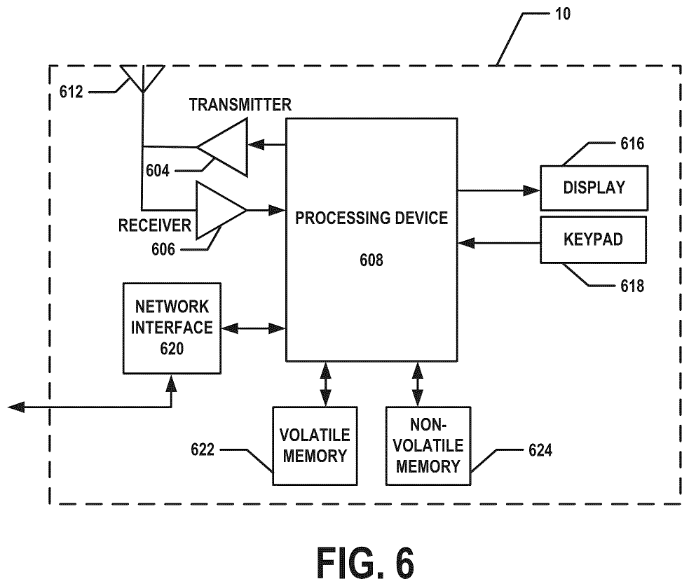

FIG. 6 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110.

As shown in FIG. 6, a computing entity 10 can include an antenna 612, a transmitter 604 (e.g., radio), a receiver 606 (e.g., radio), and a processing device 608 that provides signals to and receives signals from the transmitter 604 and receiver 606, respectively. The signals provided to and received from the transmitter 604 and the receiver 606, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

For example, the processing device 608 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products.

In various embodiments, the computing entity 10 may comprise a network interface 620 for interfacing and/or communicating with the controller 30, for example, via one or more wired and/or wireless networks. For example, the computing entity 10 may comprise a network interface 620 for providing executable instructions, command sets, and/or the like for receipt by the controller 30 and/or receiving output and/or the result of a processing the output provided by the quantum computer 110. In various embodiments, the computing entity 10 and the controller 30 may communicate via a direct wired and/or wireless connection and/or via one or more wired and/or wireless networks 20.

The computing entity 10 may also comprise a user interface device comprising one or more user input/output interfaces (e.g., a display 616 and/or speaker/speaker driver coupled to a processing device 608 and a touch screen, keyboard, mouse, and/or microphone coupled to a processing device 608). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 618 (hard or soft), a touch display, voice/speech or motion interfaces, scanners, readers, or other input device. In embodiments including a keypad 618, the keypad 618 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 622 and/or non-volatile storage or memory 624, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### Conclusion

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
controlling, by a controller, operation of one or more potential sources to cause a first plurality of potential generating signals to be applied to respective potential generating elements of a confinement apparatus, wherein application of the first plurality of potential generating signals to the respective potential generating elements causes a potential well to be generated such that an object crystal comprising a plurality of atomic objects is confined within the potential well and the plurality of atomic objects comprises at least two different species of atomic objects;
controlling, by the controller, operation of the one or more potential sources to cause a second plurality of potential generating signals to be applied to the respective potential generating elements, wherein application of the second plurality of potential generating signals to the respective potential generating elements causes at least two potential wells to be generated such that a first subset of the plurality of atomic objects is confined in a first potential well of the at least two potential wells and a second subset of the plurality of atomic objects is confined in a second potential well of the at least two potential wells;
controlling, by the controller, operation of one or more manipulation sources to cause one or more first manipulation signals to be incident on the first subset of the plurality of atomic objects;
receiving, by the controller, a first sensor signal generated by a photodetector configured to capture fluorescence signals generated by the first subset of the plurality of atomic objects;
controlling, by the controller, operation of the one or more potential sources to cause a third plurality of potential generating signals to be applied to the respective potential generating elements, wherein application of the third plurality of potential generating signals to the respective potential generating elements causes the first subset of the plurality of atomic objects and a first atomic object from the second subset of the plurality of atomic objects to be confined within the first potential well and a first remainder of the second subset of the plurality of atomic objects to be confined with the second potential well;
controlling, by the controller, operation of the one or more manipulation sources to cause one or more second manipulation signals to be incident on the first subset of the plurality of atomic objects and the first atomic object from the second subset of the plurality of atomic objects confined within the first potential well;
receiving, by the controller, a second sensor signal generated by a photodetector configured to capture fluorescence signals generated by the first subset of the plurality of atomic objects and the first atomic object from the second subset of the plurality of atomic objects confined within the first potential well; and
determining, by the controller, a species of the first atomic object.

2. The method of claim 1, further comprising:
controlling, by the controller, operation of the one or more potential sources to cause a fourth plurality of potential generating signals to be applied to the respective potential generating elements, wherein application of the fourth plurality of potential generating signals to the respective potential generating elements causes the first subset of the plurality of atomic objects, the first atomic object from the second subset of the plurality of atomic objects, and a second atomic object from the second subset of the plurality of atomic objects to be confined within the first potential well and a second remainder of the second subset of the plurality of atomic objects to be confined with the second potential well;
controlling, by the controller, operation of the one or more manipulation sources to cause one or more third manipulation signals to be incident on the first subset of the plurality of atomic objects, the first atomic object from the second subset of the plurality of atomic objects, and the second atomic object from the second subset of the plurality of atomic objects confined within the first potential well;
receiving, by the controller, a third sensor signal generated by a photodetector configured to capture fluorescence signals generated by the first subset of the plurality of atomic objects, the first atomic object from the second subset of the plurality of atomic objects, and the second atomic object from the second subset of the plurality of atomic objects confined within the first potential well; and
determining, by the controller, a species of the second atomic object.

3. The method of claim 1, wherein the first subset of the plurality of atomic objects consists of a single atomic object and the process is repeated until at least one of (a) all but one atomic object from the second subset of the plurality of atomic objects are confined by the first potential well or (b) all atomic objects from the second subset of the plurality of atomic objects are confined by the first potential well.

4. The method of claim 1, further comprising, based at least in part on the species of the first atomic object, determining an order of the plurality of atomic objects of the object crystal.

5. The method of claim 1, wherein each atomic object of the plurality of atomic objects has the same charge.

6. The method of claim 1, wherein the one or more potential sources are voltage sources, the potential generating signals are voltage signals, the respective potential generating elements are respective control electrodes, the one or more manipulation sources are lasers, the one or more first manipulation signals and the one or more second manipulation signals are laser beams, the plurality of atomic objects is a plurality of ions, and the confinement apparatus is an ion trap.

7. The method of claim 1, wherein the one or more first manipulation signals comprise a manipulation signal characterized by a first fluorescence wavelength and a manipulation signal characterized by a second fluorescence wavelength, an atomic object of a first species of the at least two different species fluoresces at the first fluorescence wavelength, and an atomic object of a second species of the at least two different species fluoresces at the second fluorescence wavelength.

8. The method of claim 1, wherein the species of the first atomic object is determined based at least in part on a comparison of the first sensor signal and the second sensor signal or a comparison of one or more values determined by processing the first sensor signal and one or more values determined by processing the second sensor signal.

9. The method of claim 1, further comprising, based at least in part on the species of the first atomic object, whether an order of the plurality of atomic objects within the object crystal is a desired order.

10. The method of claim 9, further comprising, responsive to determining that the order of the plurality of atomic objects within the object crystal is not the desired order, causing a reordering of the plurality of atomic objects within the object crystal.

11. A system comprising:
a confinement apparatus comprising a plurality of potential generating elements;
one or more potential sources configured to generate and provide potential generating signals such that the potential generating signals are applied to respective potential generating elements of the plurality of potential generating elements;
one or more manipulation sources configured to generate and provide one or more manipulation signals such that the one or more manipulation signals are incident at a target location defined at least in part by the confinement apparatus; and
a controller configured to control operation of the one or more potential sources and the one or more manipulation sources, wherein the controller comprises a memory storing executable instructions and at least one processor, the executable instructions are configured to, when executed by the at least one processor, cause the controller to perform:
controlling operation of one or more potential sources to cause a first plurality of potential generating signals to be applied to respective potential generating elements of the confinement apparatus, wherein application of the first plurality of potential generating signals to the respective potential generating elements causes a potential well to be generated such that an object crystal comprising a plurality of atomic objects is confined within the potential well and the plurality of atomic objects comprises at least two different species of atomic objects;
controlling operation of the one or more potential sources to cause a second plurality of potential generating signals to be applied to the respective potential generating elements, wherein application of the second plurality of potential generating signals to the respective potential generating elements causes at least two potential wells to be generated such that a first subset of the plurality of atomic objects is confined in a first potential well of the at least two potential wells and a second subset of the plurality of atomic objects is confined in a second potential well of the at least two potential wells;
controlling operation of one or more manipulation sources to cause one or more first manipulation signals to be incident on the first subset of the plurality of atomic objects;
receiving a first sensor signal generated by a photodetector configured to capture fluorescence signals generated by the first subset of the plurality of atomic objects;
controlling operation of the one or more potential sources to cause a third plurality of potential generating signals to be applied to the respective potential generating elements, wherein application of the third plurality of potential generating signals to the respective potential generating elements causes the first subset of the plurality of atomic objects and a first atomic object from the second subset of the plurality of atomic objects to be confined within the first potential well and a first remainder of the second subset of the plurality of atomic objects to be confined with the second potential well;
controlling operation of the one or more manipulation sources to cause one or more second manipulation signals to be incident on the first subset of the plurality of atomic objects and the first atomic object from the second subset of the plurality of atomic objects confined within the first potential well;
receiving a second sensor signal generated by a photodetector configured to capture fluorescence signals generated by the first subset of the plurality of atomic objects and the first atomic object from the second subset of the plurality of atomic objects confined within the first potential well; and
determining a species of the first atomic object.

12. The system of claim 11, wherein the executable instructions are further configured to, when executed by the at least one processor, cause the controller to perform further:
controlling operation of the one or more potential sources to cause a fourth plurality of potential generating signals to be applied to the respective potential generating elements, wherein application of the fourth plurality of potential generating signals to the respective potential generating elements causes the first subset of the plurality of atomic objects, the first atomic object from the second subset of the plurality of atomic objects, and a second atomic object from the second subset of the plurality of atomic objects to be confined within the first potential well and a second remainder of the second subset of the plurality of atomic objects to be confined with the second potential well;
controlling operation of the one or more manipulation sources to cause one or more third manipulation signals to be incident on the first subset of the plurality of atomic objects, the first atomic object from the second subset of the plurality of atomic objects, and the second atomic object from the second subset of the plurality of atomic objects confined within the first potential well;
receiving a second sensor signal generated by a photodetector configured to capture fluorescence signals generated by the first subset of the plurality of atomic objects, the first atomic object from the second subset of the plurality of atomic objects, and the second atomic object from the second subset of the plurality of atomic objects confined within the first potential well; and
determining a species of the second atomic object.

13. The system of claim 11, wherein the first subset of the plurality of atomic objects consists of a single atomic object and the process is repeated until at least one of (a) all but one atomic object from the second subset of the plurality of atomic objects are confined by the first potential well or (b) all atomic objects from the second subset of the plurality of atomic objects are confined by the first potential well.

14. The system of claim 11, wherein the executable instructions are further configured to, when executed by the at least one processor, cause the controller to perform, based at least in part on the species of the first atomic object, determining an order of the plurality of atomic objects of the object crystal.

15. The system of claim 11, wherein each of atomic object of the plurality of atomic objects has the same electric charge.

16. The system of claim 11, wherein the one or more potential sources are voltage sources, the potential generating signals are voltage signals, the respective potential generating elements are respective control electrodes, the one or more manipulation sources are lasers, the one or more first manipulation signals and the one or more second manipulation signals are laser beams, the plurality of atomic objects is a plurality of ions, the confinement apparatus is an ion trap, and the plurality of potential generating elements is a plurality of electrodes.

17. The system of claim 11, wherein the one or more first manipulation signals comprise a manipulation signal characterized by a first fluorescence wavelength and a manipulation signal characterized by a second fluorescence wavelength, an atomic object of a first species of the at least two different species fluoresces at the first fluorescence wavelength, and an atomic object of a second species of the at least two different species fluoresces at the second fluorescence wavelength.

18. The system of claim 11, wherein the species of the first atomic object is determined based at least in part on a comparison of the first sensor signal and the second sensor signal or a comparison of one or more values determined by processing the first sensor signal and one or more values determined by processing the second sensor signal.

19. The system of claim 11, wherein the executable instructions are further configured to, when executed by the at least one processor, cause the controller to perform:
based at least in part on the species of the first atomic object, determining whether an order of the plurality of atomic objects within the object crystal is a desired order; and
responsive to determining that the order of the plurality of atomic objects within the object crystal is not the desired order, controlling operation of the one or more potential sources to cause a reordering of the plurality of atomic objects within the object crystal.

20. A method comprising:
controlling, by a controller, operation of one or more potential sources to cause a first plurality of potential generating signals to be applied to respective potential generating elements of a confinement apparatus, wherein application of the first plurality of potential generating signals to the respective potential generating elements causes a potential well to be generated such that an object crystal comprising a plurality of atomic objects is confined within the potential well and the plurality of atomic objects comprises at least two different species of atomic objects;
controlling, by the controller, operation of the one or more potential sources to cause a second plurality of potential generating signals to be applied to the respective potential generating elements, wherein application of the second plurality of potential generating signals to the respective potential generating elements causes at least two potential wells to be generated such that a first subset of the plurality of atomic objects is confined in a first potential well of the at least two potential wells and a second subset of the plurality of atomic objects is confined in a second potential well of the at least two potential wells, wherein the first subset of the plurality of atomic objects consist of one or more atomic objects;
controlling, by the controller, operation of one or more manipulation sources to cause one or more first manipulation signals to be incident on the first subset of the plurality of atomic objects;
receiving, by the controller, a first sensor signal generated by a photodetector configured to capture fluorescence signals generated by the first subset of the plurality of atomic objects; and
processing the first sensor signal to determine a respective species of at least one atomic object of the one or more atomic objects of the first subset of the plurality of atomic objects.
